(19) United States
(12) Patent Application Publication
(10) Pub. No.: US 2025/0299550 A1
(43) Pub. Date: Sep. 25, 2025

(54) POOL GUARDIAN AND SURVEILLANCE SAFETY SYSTEMS AND METHODS

(71) Applicant: Kourai Inc., Goleta, CA (US)

(72) Inventors: Samuel Rosaire Dib Boulanger, Goleta, CA (US); Pierre Michel Boulanger, Goleta, CA (US)

(21) Appl. No.: 19/228,597

(22) Filed: Jun. 4, 2025

Related U.S. Application Data
(63) Continuation of application No. PCT/US2023/082383, filed on Dec. 4, 2023.
(60) Provisional application No. 63/386,041, filed on Dec. 5, 2022.

(51) Int. Cl. G08B 21/08; E04H 4/06; E04H 4/14

(52) U.S. Cl. CPC G08B 21/086; E04H 4/06; E04H 4/14

(57) ABSTRACT

Drowning remains the leading cause of death for kids under the age of four. Provided herein are software and hardware technologies that allow for monitoring of water that rivals the performance of a real lifeguard human that may be assigned in doing surveillance of a pool. By incorporating at least two cameras with different points of views, high-definition speakers to interact with the responsible parties in a natural way, and computing power to process all the visual information to flawlessly track all the patrons and recognize their gestures, the system may possibly exceed a human performance in guarding the pool.

### CROSS-REFERENCE TO RELATED APPLICATIONS

This application is a continuation of International Patent Application No. PCT/US2023/082383 filed Dec. 4, 2023 and entitled “POOL GUARDIAN AND SURVEILLANCE SAFETY SYSTEMS AND METHODS,” which claims priority to and the benefit of U.S. Provisional Patent Application 63/386,041 filed Dec. 5, 2022, and entitled “POOL GUARDIAN AND SURVEILLANCE SAFETY SYSTEM,” which are hereby incorporated by reference in their entirety.

### TECHNICAL FIELD

The present invention is directed to a pool guardian and surveillance safety systems and methods of operation. More specifically, the present disclosure relates to a surveillance system for recognizing and alerting responsible parties of dangerous situations occurring within an environment containing water.

### BACKGROUND

Recreational activities conducted in areas containing water can be dangerous and life-threatening. Even with qualified personnel actively monitoring such areas, harmful events, such as drownings, can still occur. Additionally, recreational areas containing water at a residence, such as a pool, may not have personnel surveying the area. In home pool environments, the lifeguarding responsibility is given to a caregiver. In the home environment, there exist multiple distractions and it is common that the caregiver will divert their attention toward another event, leaving the pool without highly focused surveillance. It is also common for curious toddlers to find their way to the pool without the caregivers noticing that they have left. There are also instances where a non-swimming child playing with skilled swimming friends may be pushed to their swimming capability limits and suffer a drowning incident, even amongst other kids and adults. Conventional pool monitoring systems may provide means of viewing an area having water but, in a life-saving situation, it is critical that the performance and user interface of the system be as good or better that a human lifeguard doing the surveillance.

### SUMMARY OF THE DISCLOSURE

Disclosed herein are systems and methods for realizing a high-performance computerized pool guardian with imaging systems and high-fidelity speakers. A novel multi-technology-based tracking and decision-making system, that includes several convolutional neural networks that extract detailed information from sensors around a pool, filter that information for potentially dangerous event, clearly communicate the situation to humans, and enable the patrons to signal the system to modify its behavior. Since the system is highly versatile, other concurrent modes of operation are provided in addition to the warning of dangers; the guardian system also provides games and fitness functionality to provide usefulness to users beyond black swan events.

Provided in this disclosure is a surveillance system including: two or more imaging modules, wherein each of the two or more imaging modules is configured to provide image data of an environment having a body of water; a processing unit communicatively connected to one or more imaging modules; and a memory communicatively connected to the processor, wherein the memory comprises instructions configuring the processor to: receive the image data of the environment from each of the plurality of imaging modules; identify, using a neural network, one or more objects within the environment based on the image data, wherein identifying the one or more objects comprises associating an object identifier with each of the one or more objects; determine status data of the one or more objects based on the image data and/or object identifier; determine a critical event related to at least one of the objects of the one or more objects based on the status data and a distress parameter; and generate an alert based on the detection of the critical event.

Provided in this disclosure is a method of monitoring an environment having a body of water, the method including providing, by two or more imaging modules, image data of an environment having a body of water; a processing unit communicatively connected to the plurality of imaging modules; and a memory communicatively connected to the processor, wherein the memory comprises instructions configuring the processor to: receiving, by a processing unit communicatively connected to the two or more imaging modules, the image data of the environment from each of the plurality of imaging modules; identifying, using a neural network, one or more objects within the environment based on the image data, wherein identifying the one or more objects comprises associating an object identifier with each of the one or more objects; determining, by the processing unit, status data of the one or more objects based on the image data, and the object identifier; determining, by the processing unit, a critical event related to at least one object of the one or more objects based on the status data and a distress parameter; and generating, by the processing unit, an alert based on the detection of the critical event.

In some embodiments of the present disclosure, a guarding system comprises of a minimum of two video cameras, one or multiple audio modules to output instructions and capture sounds, a computing system that process all their relayed video images, communication medium (Wi-Fi or other) to link the local processing with the cameras, audio modules and extra processing devices, and computer programs to extract the received information, determine a course of action, and execute it. Cloud computing may also be used to assist in the communication and management of the system.

In some embodiments of the present disclosure, the computer program incorporates an elaborate tracker of patrons that reports the location in 3D space of each patron, and the status of each track's robustness. In some embodiment of the present disclosure, the tracker process utilizes the information from all sensors, multiple neural networks, location in 3D space, motion estimation information, historical and statistical patrons' information, to robustly locate all patrons in the field of views of any sensor. In some embodiment of the present disclosure, the computer program utilizes deep convolutional neural networks to process individual images to locate and classify patrons of interest like people, animals, or objects. In some embodiment of the present disclosure, the computer program utilizes deep neural network detection to determine if a patron is underwater, partially submerged, or over-water, locate its head, locate its body, locate water contact point, and identify communicating gesture signals. In some embodiment of the present disclosure, the computer program processes the images of a minimum of two cameras and uses the extracted information in its tracking algorithm. In some embodiment of the present disclosure, the computer program utilizes deep convolutional neural network feature extractors on each patron in the tracking algorithm to learn to distinguish individual persons. For example, the patron's age, specific identification, and re-identification after being obstructed may be determined using neural network feature extractor technology.

In some embodiments of the present disclosure, the system calculates the location in three-dimensional space of each patron and utilizes that information in the tracking algorithm.

In some embodiments of the present disclosure, the computer program incorporates motion prediction algorithms and utilizes that information in its tracking algorithm.

In some embodiment of the present disclosure, a calibration step utilizes a segmentation neural network to determine the edges of the pool and locate it in the 3D space.

In some embodiments of the present disclosure, a calibration process may utilize a known size object like a square meter floating board, to assist in the accurate construction of 3D space in the field of view. Specific steps and equipment like a smartphone may be used in a prescribed process to enable the construction of the 3D space.

In some embodiments of the present disclosure, the tracking process changes the order and weight of each level of its cascade matching algorithm, depending on the live situation, system status, and detection characteristics (e.g., size, confidence, location).

In some embodiments of the present disclosure, the output model of a feature extractor convolutional neural network is stored in a database of patrons, so when the same patrons return to the scene, their swimming skill parameters and other preferences can be retrieved and associated with him/her instead of system defaults.

In some embodiments of the present disclosure, the computer program utilizes deep neural networks to approximate the age of the people in the field of view of the cameras.

In some embodiments of the present disclosure, the images may be cropped from the full-size images so all pixels will be used to classify far away targets.

In some embodiments of the present disclosure, the behavior of the system changes according to the identity of each patron, the age of each patron, the context of the patron's presence, the direct interactions with other patrons, the movement style of the patrons, the sound made by patrons, the directives given by a responsible patron.

In some embodiments of the present disclosure, the behavior of the system changes according to the user-selected mode of operation; non-pool-time, pool-time, out-of-season, good-swimmers-only, are some examples of selectable modes of operation of the system that changes the responses.

In some embodiments of the present disclosure, each patron has a default status for his/her presence, which includes but not limited to swimming skill level, age, identification, location, direction, speed, supervisory presence, active interactions, medical condition risk; the status is constantly updated by the system as information is gathered by the sub-systems.

In some embodiment of the present disclosure, each patron's underwater time is closely monitored using tracker output classification and tabulated for consecutive time so warnings and alerts may be generated when individual patron's maximum times for various alerts levels are reached.

In some embodiments of the present disclosure, the system monitors the captured audio for distress words; although not limited to only that word, an example include: “HELP”.

In some embodiments of the present disclosure, the system monitors dangerous actions; although not limited to only those actions, examples include running around the pool, diving in shallow water, jumping on someone in the pool.

In some embodiments of the present disclosure, the direction and speed of each patron is used to predict potential dangers; a toddler running toward the pool secure perimeter may generate an alert, but the same toddler that is stationary on the same secure perimeter edge may only cause a warning.

In some embodiments of the present disclosure, the system behavior changes according to distance between patrons; a toddler that is in very close proximity or in direct contact with a good swimmer may have relaxed parameters before alerts are generated, where the same toddler that is more than a meter away will be subject to strict underwater warnings.

In some embodiments of the present disclosure, the system monitors impairments in the images received from the cameras and warns responsible parties about the reduced efficiency; although not limited to only those impairments, examples include: blinded by the sun, obstructed by ice or water or snow, obstructed by large objects, obstructed by close insect or bird or animal, obstructed by close leaf or debris, loss of power, poorly illuminated night time, obstructed by large object blocking visibility to the pool area.

In some embodiment of the present disclosure, the system communicates warnings and alerts utilizing both audio means via speakers, and electronic means via messages to mobile phones. Strobing bright lights may also be used to indicate a warning condition.

In some embodiments of the present disclosure, the system incorporates several levels of warnings and alerts; although not limited to only those alert methods, examples include: simple voice instructions, loud but short high pitch chirp followed by voice instructions, loud and long high pitch chirp followed by voice instructions, repeating loud high pitch sound with informative voice description of issue, electronic messaging describing the warning.

In some embodiment of the present disclosure, the system utilizes visible and/or infrared illumination to keep high image quality at nighttime.

In some embodiments of the present disclosure, the system may be used in an intruder alert security mode where additional features are provided. Although not limited to only those features, examples include permanent storage, presence detection warning, virtual fence definition, event browsing on recorded video, anomaly detection.

In some embodiments of the present disclosure, the system periodically reports the status of the efficiency of all its sub-components via a cloud network connection so a remote reliable cloud system can communicate warnings via cell phone messaging if there is an ineffectiveness of the pool protection. Although not limited to only those failures, examples include complete power loss, low battery condition of component, Wi-Fi loss, poor Wi-Fi connectivity, poor visibility, loss of communication with component, loss of speaker functionality, loss of microphone functionality.

In some embodiments of the present disclosure, the system monitors and identifies specific hand gestures of individuals for instructions; although not limited to only those situations, the system accepts hand signals for the following reasons: relax its warning level limits, signal focused human attention and change the system behavior, trigger the system to start the identification process and personalize the system parameters.

In some embodiment of the present disclosure, the system recognizes hand gestures commands by first recognizing a specific “key” hand gesture, then immediately followed by second gesture that represent the command; although not limited to only those gestures, examples include: thumbs up gesture, peace sign over the head, pointing up or down, time out sign.

In some embodiments of the present disclosure, the system outputs human voice recordings in its speakers to provide directives and information to the pool area and anywhere the speakers are located; although not limited to only those words, examples include: “stop running please”, “toddler approaching the pool”, “person underwear for too long”, “please move the obstacle, I can't see”, “please all check in, I can't see Zach”.

In some embodiments of the present disclosure, the system utilized its speaker system to output high pitch loud alarm sounds that are appropriate to the warning and alarm level; although not limited to only those sounds, examples include: a quick chirp from a lifeguard whistle, an insisting chirp from a lifeguard whistle, repeated whistling, person shouting ‘alarm’, smoke-alarm pitch alarm, car-alarm pitch alarm.

In some embodiments of the present disclosure, the guardian system displays on its portable device app, a real-time 3D representation of movement around the area under surveillance, over a background formed of recognized objects and textures from the area.

In some embodiments of the present disclosure, a three-dimensional (3D) representation of the area's fixed features is constructed in prescribed calibration steps. Dense mesh creation algorithm, segmentation and classification neural networks, and other coordinating software create the 3D area utilizing captured video from the installed system cameras and the video captured from a smartphone of the pool grounds which is captured from an installer walking around. Although not limited to only those features, examples the 3D constructed map will include pool edges, slides, springboard, waterfall, jacuzzi, home edges, fence edges, trees, sheds, doors, grass areas.

In some embodiments of the present disclosure, detection neural networks are utilized to classify objects which are then projected on the 3D map; although not limited to only those objects, examples include: people, animals, chairs, toys, tools.

In some embodiments of the present disclosure, the displayed icons in the portable device app may be selected by the user to get more information on that object; although not limited to this list, examples may be camera icon to view the camera's real time stream, water temperature, stream microphone feed, activate intercom with speaker, patron's identification.

In some embodiment of the present disclosure, the level of alertness of a patron is represented in his/her icon on the 3D map, by changing the appearance of the icon.

In some embodiment of the present disclosure, the orientation of the smart device is used to display the information in different formats; although not limited to this example, the vertical view may display the events timeline while the horizontal view displays the 3D view.

In some embodiments of the present disclosure, a smart phone app is used to provide a user interface to the users and communicate with the system; although not limited to only those features, examples include displaying 3D map, displaying camera feeds, configuration of the system parameters, receiving system warnings/alarms, output audio streams, transmit audio streams, snap shots of alarm event, access to recorded video feeds, storage of events log.

In some embodiments of the present disclosure, the system audio modules can be used to provide an intercom functionality where real time audio streams are passed at both ends points; the end points are selected audio modules; and could also include a smart phone app.

In some embodiments of the present disclosure, the system provides various games that can be played with it; the speakers, cameras, and interactive functionality of the system enable to run various entertaining pool games; although not limited to only those games, examples include red-light-green-light, Marco-Polo with a virtual player, Simon-says, race coordinator for races against time, coordinator to report lap count and lap times.

In some embodiments of the present disclosure, the system is able to identify images that are of interest to improve the performance of the system and store them locally to eventually be communicated back to the factory for use in training or testing of new revisions of the neural networks and tracker.

In some embodiments of the present disclosure, the system interfaces with external sensors to complement its capabilities; although not limited to this list, examples include interfacing to floating sensors, interfacing with underwater cameras, interfacing with Smart Speakers, interfacing with home security system components like door latches and motion detectors.

In some embodiment of the present disclosure, the cameras may use camera sensors of large size to enable digital zoom functionality to be used by the automatic calibration process to simplify installation.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1A illustrates a block diagram of an exemplary embodiment of a water surveillance system in a home pool environment in accordance with one or more embodiments of the present disclosure.

FIG. 1B illustrates a schematic drawing of an exemplary embodiment of a water surveillance system in a home pool environment in accordance with one or more embodiments of the present disclosure.

FIG. 2 illustrates a block diagram showing an example implementation of the hardware components of the pool guardian system in accordance with one or more embodiments of the present disclosure.

FIG. 3A illustrates a flow chart of an exemplary method of monitoring an environment by water surveillance system in accordance with one or more embodiments of the present disclosure.

FIG. 3B illustrates a flow chart of the exemplary method of monitoring an environment by water surveillance system in accordance with one or more embodiments of the present disclosure.

FIG. 4A illustrates an exemplary embodiment of visual representations of water surveillance system with metadata of detector neural network identified in accordance with one or more embodiments of the present disclosure.

FIG. 4B illustrates an exemplary embodiment of cropped images with metadata, which are output from the pool guardian system's feature extractor neural network in accordance with one or more embodiments of the present disclosure.

FIG. 4C illustrates an exemplary embodiment of cropped images with metadata, which is an output from the pool guardian system's tracker, prior to transfer on a bird's eye view in accordance with one or more embodiments of the present disclosure.

FIG. 4D illustrates an exemplary embodiment of a bird's eye view of the scene example of Error! Reference source not found. A in accordance with one or more embodiments of the present disclosure.

FIGS. 5A-5F illustrate an exemplary embodiment of a use-case of a water surveillance system detecting danger and generating warning that is proportional to the situation in accordance with one or more embodiments of the present disclosure.

FIG. 6 illustrates an exemplary embodiment of a use-case of the guardian system detecting danger and generating warning that is proportional to the situation in accordance with one or more embodiments of the present disclosure.

FIGS. 7A-7F illustrate exemplary embodiments of a live command interaction with the pool guardian system in accordance with one or more embodiments of the present disclosure.

FIG. 8 illustrates an exemplary embodiment of a voice directive from the pool guardian system in accordance with one or more embodiments of the present disclosure.

FIG. 9 illustrates an exemplary embodiment of a use-case of the guardian system detecting danger and generating warning that is proportional to the situation in accordance with one or more embodiments of the present disclosure.

FIG. 10 illustrates an exemplary embodiment of a use-case of the guardian system detecting danger from voice recognition only and generating warning that is proportional to the situation in accordance with one or more embodiments of the present disclosure.

FIG. 11 illustrates an exemplary embodiment of a use-case of the guardian system detecting an obstruction to its optimal view and instructing the patrons to remove it in accordance with one or more embodiments of the present disclosure.

FIG. 12 illustrates an exemplary embodiment of a calibration scene where a known object is placed in the field of view of both cameras in accordance with one or more embodiments of the present disclosure.

Embodiments of the invention and their advantages are best understood by referring to the detailed description that follows. It should be appreciated that like reference numerals are used to identify like elements illustrated in one or more of the figures.

### DETAILED DESCRIPTION

Aspects of the present disclosure are directed to a pool guardian and surveillance safety system and corresponding methods for monitoring an environment with water. More specifically, the present disclosure may include a water surveillance system used for monitoring an environment, which may include a recreational area of a residence, such as a pool, to prevent dangerous or life-threatening events from occurring. For example, water surveillance system may be configured to monitor an environment using two or more imaging modules. In one or more embodiments, two or more imaging modules may each generate image data that may then be processed by a logic device, such as a processing unit, to determine if an object, such as a child, is in danger of drowning.

In other aspects of the present disclosure, water surveillance system may include two or more cameras and/or speakers to provide reliable assistance in water surveillance that is unwavering, un-distractable, and executes detailed surveillance on multiple objects (e.g., patrons), all at the same time. Hardware required to realize such a system (e.g., cameras, computing power, speakers, microphones, communication network) is now commoditized, so an affordable system can be high performing if the software algorithms and user interface are executed with the goal of being uncompromising. In various embodiments, one or more machine-learning models or neural networks may be implemented to provide the required performance, where multiple deep convolutional neural networks of different architectures, sensor specific motion estimating filters, correlation between sensors using precise localization in 3D space, tracking in unified three-dimensional space, state machines to aggregate all the information, dictate the correct course of action, and communicate it clearly, all combine to form such a system.

In the detailed description of the embodiments, references are made to the included figures which add clarity in the descriptions. It should be understood however that the figures do not represent all the embodiments of the invention.

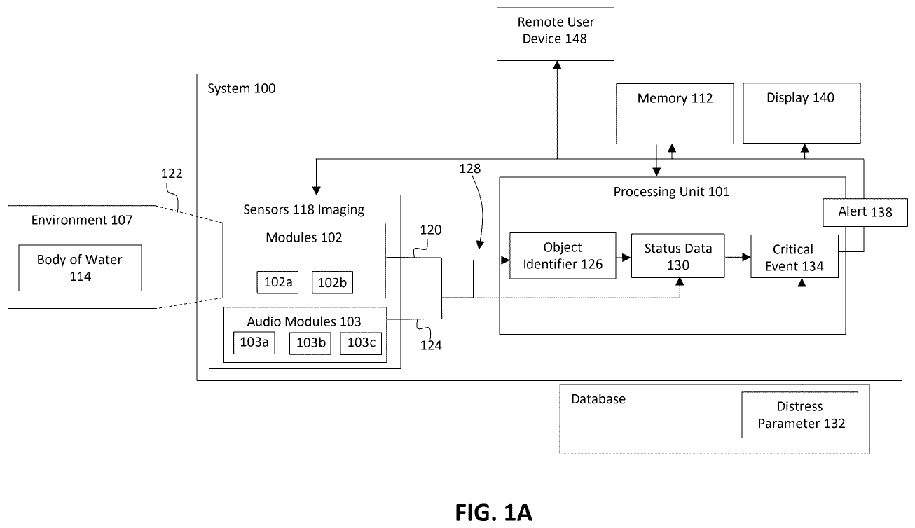

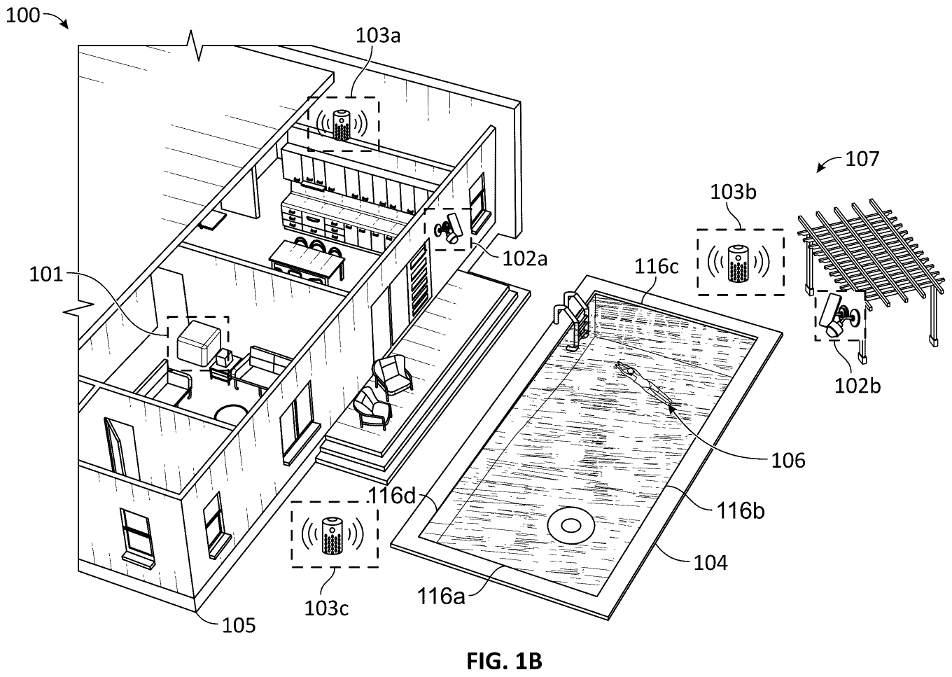

Now referring to FIG. 1A, a block diagram of an exemplary embodiment of pool guardian and surveillance safety system 100 is shown in accordance with one or more embodiments of the present disclosure. Pool guardian and surveillance safety system 100 (also referred to in this disclosure as “water surveillance system”, “surveillance system”, and “system”) may be configured to monitor an area of interest, such as, for example, an environment 107 having a body of water 114. For instance, environment 107 may include a scene containing a liquid such as a beach, dock, public or private recreational area, residence, communal area, water park, and the like. A body of water may include a pool (e.g., pool 104 shown in FIG. 1B), jacuzzi, pond, lake, ocean, river, shoreline, water park attraction, fountain, waterway, and the like. For example, as shown in FIG. 1, environment 107 may include a residential pool located in the backyard of a home or communal area of a residential community.

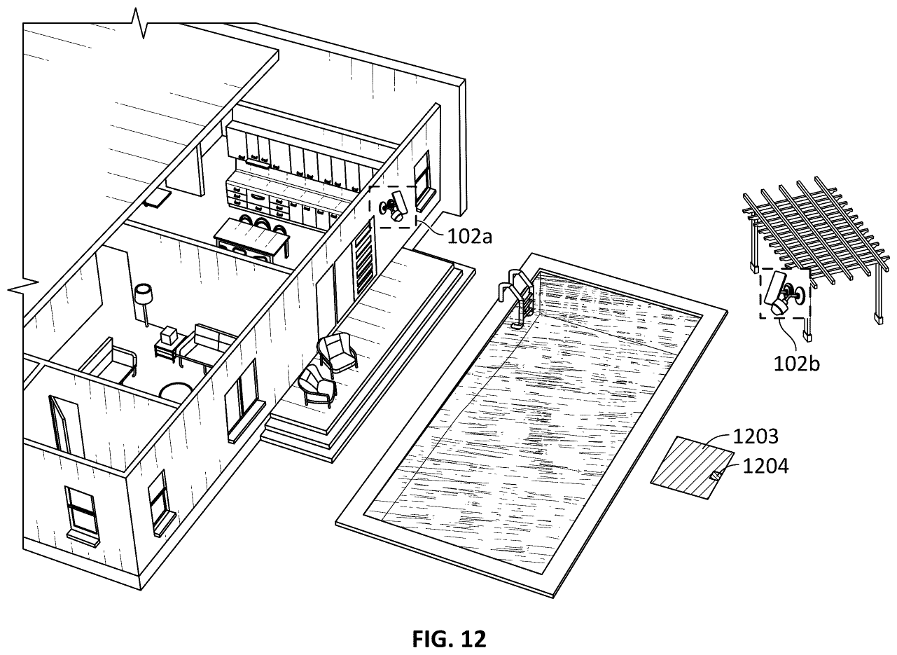

In one or more embodiments of the present disclosure, body of water 114 of environment 107 may be defined within environment by one or more physical boundaries. For example, pool 104 may include physical boundaries that include edges 116a, 116b, 116c, and 116d (as shown in FIG. 1B). Physical boundaries, such as edges 116a-d, may delineate where body of water 114 begins or ends relative to environmental surroundings. For example, edges 116a-d include edges of land (e.g., concrete) providing a perimeter of pool 104 within environment 107. In one or more embodiments, a calibration step utilizes a segmentation neural network to determine the edges of the pool and locate it in the 3D space, as discussed further in this disclosure. In other embodiments, a calibration process may utilize a known size object like a square meter floating board, to assist in the accurate construction of 3D space in the field of view (as described further in FIG. 12). In some embodiments, system 100 may display on a remote user device or display 140 a real-time 3D representation of movement around an area under surveillance (e.g., environment 107), over a background formed of recognized objects and textures from the area.

Specific steps and equipment like a smartphone may be used in a prescribed process to enable the construction of the 3D space. A three-dimensional (3D) representation of the area's fixed features is constructed in prescribed calibration steps. Dense mesh creation algorithm, segmentation and classification neural networks, and other coordinating software create the 3D area utilizing captured video from the installed system cameras and the video captured from a smartphone of the pool grounds which is captured from an installer walking around. Although not limited to only those features, examples the 3D constructed map will include pool edges, slides, springboard, waterfall, jacuzzi, home edges, fence edges, trees, sheds, doors, grass areas. In some embodiments, the cameras may use camera sensors of large size to enable digital zoom functionality to be used by the automatic calibration process to simplify installation.

In one or more embodiments, system 100 may include a computing device. Computing device may include any computing device as described in this disclosure, including, but not limited to, a logic device (e.g., a programmable logic device (PLD)), processing unit 101, processor, microprocessor, controller, microcontroller, digital signal processor (DSP), a printed circuit board (PCB), circuit, system on a chip (SOC), any combination thereof, and the like. Processing unit 101 may be communicatively connected to any other components described in this disclosure, such as sensors (e.g., imaging modules), a memory 112, a display 140, a database (e.g., object database), and the like. Computing device may include, be included in, and/or communicate with a remote user device, such as a mobile device (e.g., a mobile telephone or smartphone), tablet, laptop, desktop, and the like, as described further below in this disclosure. In some embodiments, computing device may include a single computing device operating independently. In other embodiments, computing device may include a plurality of computing devices operating in parallel, in concert, sequentially, or the like. Computing device may interface or communicate with one or more components of system 100 and/or devices communicatively connected to system 100 using a communication unit (e.g., a network interface device), wherein being communicatively connected includes having a wired or wireless connection that facilitates an exchange of information between devices and/or components described in this disclosure. Communicative connection may include bidirectional communication wherein data or information is transmitted and/or received from one device and/or component to another device and/or component of system 100. Communicative connection may include direct or indirect communication (e.g., using one or more intervening devices or components). Indirect connections may include wireless connections, such as Bluetooth communications, optical connections, low-power wide area networks, radio communications, magnetics, or the like. In one or more embodiments, direct connections may include physical connections or coupling between components and/or devices of system 100. For example, in one or more embodiments, communicative connection may include an electrical connection, where an output of a first device may be received as an input of a second device and vice versa using the electrical connection. Communicative connection may be facilitated by a bus or other component used for intercommunication between one or more components of computing device. In one or more embodiments, communication unit may be configured to connect computing device to one or more types of networks, and one or more devices. Communication unit may include a network interface card (e.g., a mobile network interface card or a LAN card), a modem, and any combination thereof, and the like. A network may include a telephone network, wide area network (WAN), a local area network (LAN), a data network associated with a provider, a direct connection between one or more components of system 100 or remote devices, any combinations thereof, or the like. In one or more embodiments, communication unit may use transmission media to transmit and/or receive information. Transmission media may include coaxial cables, copper wire, fiber optics, and the like. Transmission media may include or convey light waves, electromagnetic emissions, acoustic waves, and the like.

In one or more embodiments, system 100 may include a memory 112, where memory may be communicatively connected to computing device (e.g., processing unit 101). In one or more embodiments, computing device may include image processing software, which may include software or other forms of computer executable instructions that may be stored, for example, on memory 112. In various embodiments, memory 112 may be used to store information for facilitating operation of system 100 or processing unit 101. In various embodiments, surveillance data may be stored in a database or memory 112. Database may include a relational database, a key-value retrieval datastore (e.g., NOSQL database), or any other format or structure for storage and retrieval of data, as discussed previously in this disclosure. Memory 112 may store information such as instructions to be executed by the various components of system 100 (e.g., processing unit 101), having parameters associated with one or more processing operations (e.g., image processing), analyzing or processing previously generated images, or the like. For example, processing unit 101 may be configured by memory 112 to process and/or analyze surveillance data, such as image data and audio data, generated by sensors, such as imaging modules 102a,b and audio modules, respectively, as discussed further below in this disclosure. In one or more embodiments, memory 112 may include volatile memory, such as random-access memory (RAM), static RAM (SRAM), dynamic RAM (DRAM), and the like. In other embodiments, memory 112 may include non-volatile memory, such as read-only memory (ROM), erasable programmable ROM (EPROM), electrically erasable programmable (EEPROM), programmable ROM (PROM), flash, non-volatile random-access memory (NVRAM), optical or magnetic disks, other persistent memory, and the like. In various embodiments, memory may include a computer readable medium, such as, for example, a permanent or portable memory. In one or more embodiments, a computer program product may be provided that stores software configured to, when read and executed by computing device, perform one or more steps of the processes described in this disclosure.

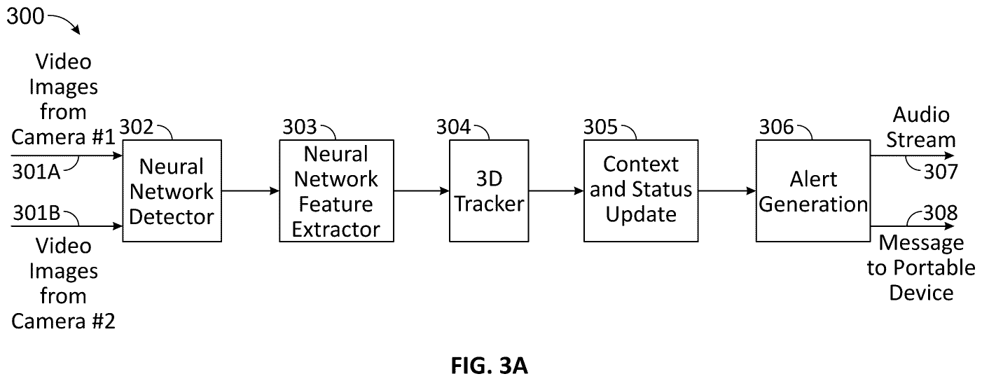

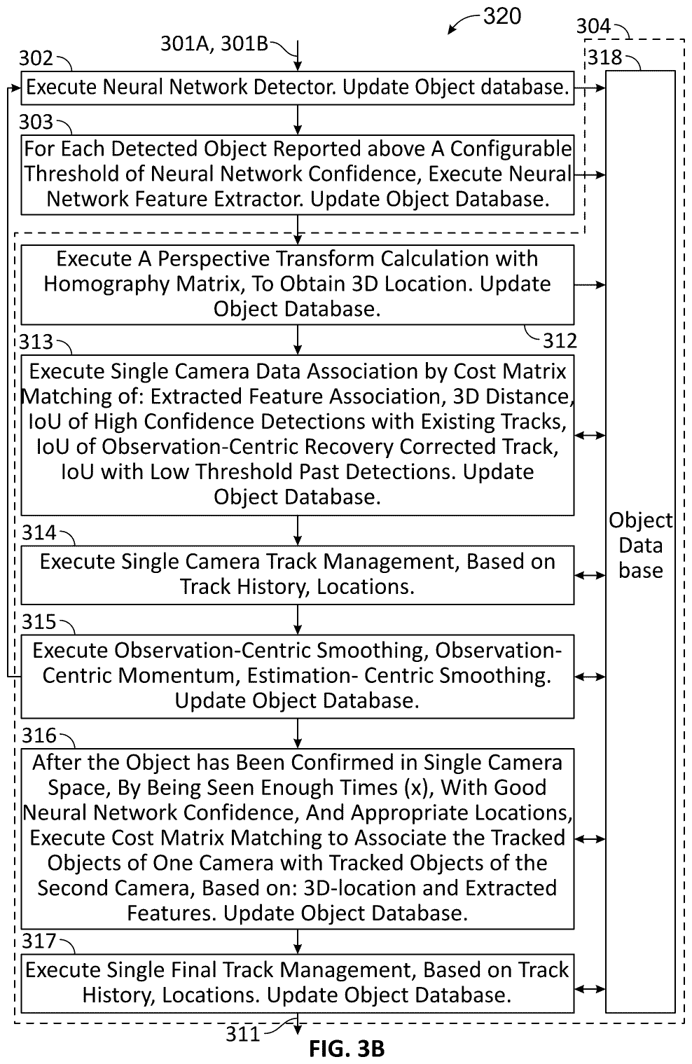

In one or more embodiments, neural networks described in this disclosure may be stored in memory 112. In one or more embodiments, programs may be stored in memory 112 and configured to be automatically executed by processing unit 101 to receive video streams from, for example, imaging modules. For each frame received from all imaging modules the following process may be executed: run detector convolutional neural networks to find objects of interest (e.g., object 106), run feature extractor convolutional neural networks on detected objects to extract further detailed description of the detected objects of interest, a two-dimensional (2D) to 3D back projection algorithm to reference the images from both cameras on a common 3D coordinates system, run sub-components of Observation-Centric SORT, DEEP SORT, Kalman filter, and other motion estimation algorithms to follow objects even when convolutional neural networks cannot clearly identify them, run dynamically configurable cost matrix algorithms utilizing all available information as matrix element to associate detection with tracks, run logical state machines to create the system behavior using all the system information that have been accumulated or derived, and output audio streams of voice and alarm sounds, and mobile device messages that clearly communicate any danger with regard to the pool activity, as described further below in, for example, FIGS. 3A and 3B.

In one or more embodiments, system 100 may include one or more sensors 118 configured to generate surveillance data. For instance, system may include a plurality of sensors, such as, for example, two or more cameras. Surveillance data may include data or information related to environment 107, such as, for example, information associated with a body of water 114 and/or an object 106 (e.g., a person) within environment 107.

In one or more embodiments, and as shown in FIG. 1, sensors 118 may include a two or more image sensors, such as, for example, imaging modules 102. Imaging modules 102 may each be configured to capture image data 120 of environment 107, which includes body of water 114. In non-limiting exemplary embodiments, imaging modules 102 may include a first imaging module 102a and a second imaging module 102b, as shown in FIG. 1. In various embodiments, imaging module 102 may include a field of view (FOV) 122 that includes at least a portion of an area of interest (e.g., environment 107), where FOV is an angular extent of a scene captured in an image of imaging module. For instance, first imaging module 102a may include a first field of view (FOV) and second imaging module and 102b may a second field of view (FOV), wherein each FOV may include at least a portion of environment 107. In some embodiments, FOVs may include the same angle or view of environment 107. In other embodiments, FOVs may include different angles or views of environment, as discussed further below in this disclosure. In one or more embodiments, computing device and/or remote user device 148 may be configured to adjust a focus or FOV of each imaging module.

In one or more embodiments, imaging module 102 may include an imaging device, such as, for example, a camera. Imaging modules 102 may be configured to capture an image, which includes image data, of a scene (e.g., area of interest and/or environment 107). In various embodiments, imaging modules 102 may include visible light and non-visible light imaging devices. For example, imagining modules 102 may include a visible spectrum imaging module, an infrared imaging module (e.g., near infrared (NIR), medium-wave infrared (MWIR), short-wave infrared (SWIR), or long-wave infrared (LWIR) imaging modules), an ultraviolet imaging module, and the like. Infrared imagining modules may include infrared sensors that may be configured to detect infrared radiation (e.g., infrared energy) of a scene (e.g., an object within environment 107). Infrared radiation may include mid-wave infrared wave bands (MWIR), long-wave infrared wave bands (LWIR), and/or other thermal imaging bands as may be desired in particular implementations. Infrared imaging module may include microbolometers or other types of thermal imaging infrared sensors arranged in any desired array pattern. For example, infrared imaging module may include arrays of 32×32 infrared sensors 64×64 infrared sensors, 80×64 infrared sensors, or any other array sizes. In various embodiments, infrared imaging module may include a vanadium oxide (VOx) detector. In one or more embodiments, imaging modules 102a,b may include pixel count that exceeds the necessary means of most installations but, in some cases, a quality digital zoon capability may be used when imaging modules have to be installed far from environment 107 or objects 106. Optical zoom options may also be provided on the imaging modules for the same reason.

In various embodiments, sensors 118 may include one or more types of sensors. For example, sensors 118 may include light sensors, motion sensors, GPSs, cameras, accelerometers, gyroscopes, microphones, electric sensors, or any combination thereof, as discussed further below in this disclosure.

In one or more embodiments, sensors 118 may include one or more electrical sensors configured to detect electrical parameters of system 100. For instance, and without limitation, electrical sensors of system 100 may be configured to detect an electrical parameter of one or more energy sources of system 100 (e.g., a battery of an imaging module or power source of logic device, and the like). In various embodiments, electrical sensors may include one or more Hall-effect sensors, thermocouples, thermistors, capacitive sensors, resistors, combination thereof, and the like. In one or more embodiments, electrical parameters of system 100 may include current, voltage, resistance, impedance, temperature, and the like. For example, a current may be detected by using a sense resistor in series with a circuit that measures a voltage drop across the sense resister. In a non-limiting exemplary embodiment, electrical sensor may be configured to detect if a power source is failing to provide power to one or more components of system 100 (e.g., imaging modules, audio modules, logic devices, and the like). In one or more embodiments, sensor 118 may be communicatively connected (e.g., wired) to an energy source using, for example, an electrical connection.

In one or more embodiments, sensor 118 may include one or more environmental sensors. Environmental sensor may include gyroscopes, accelerometers, inertial measurement units (IMUs), temperature sensors (e.g., thermometer), photoelectric sensors, photodetectors, pressure sensors, proximity sensors, humidity sensors, light sensors, infrared sensors, position sensors, oxygen sensors, global positioning systems (GPSs), microphones, any combination thereof, and the like. For example, sensor 118 may include a geospatial sensor, where geospatial sensor may include a positioning sensor using optics, radar, or light detection and ranging (Lidar). In one or more exemplary embodiments, geospatial sensor may be configured to capture geospatial data, where spatial data includes information related to the position and/or dimensions of one or more objects within environment 107 or body of water 114. Sensors 118 may be positioned about and/or within environment 107 to capture surveillance data associate with environment 107. Surveillance data may include image data 120, audio data, geospatial data, electrical parameter data, and the like. For instance, surveillance data may include a position of an object within environment 107, a dimension of an object, obstruction, body of water, or any other aspect of environment 107, an ambient temperature of environment 107, a temperature of one or more components of system 100, a power supply to one or more components of system 100, sound from an object or environment 107, and the like.

In various embodiments, sensor 118 may include a three-dimensional (3D) scanner. Three-dimensional scanner may include the use of 3D laser scanning, which includes capturing the shape of physical objects using, for example, a laser light. In some embodiments, three-dimensional laser scanners may generate point clouds of data plotted in 3D space as a virtual or digital representation of environment, as well as objects within environment). In some embodiment, detection neural network may be utilized to classify objects which are then projected on a 3D map. Although not limited to only these objects, examples include people, animals, chairs, toys, tools. In some embodiments, displayed icons in the visual representation (e.g., on display 140 or within an app of remote user device) may be selected by a user to get more information on that object. Although not limited to this list, examples may include a camera icon to view an imaging modules' real time video stream, a thermometer icon for a water temperature, a microphone icon for a stream microphone feed, and speaker icon for an activate intercom with speaker, a face or “i” icon patron's identification, and the like. In some embodiment, a level of alertness of a patron is represented in his/her icon on the 3D map, by changing the appearance of the icon. For example, an icon may change from a check mark to an exclamation point if a critical event is determined by processing unit 101. In some embodiments, the orientation of a smart device (e.g., remote user device) may be used to display information (e.g., object identifier, status data, critical events, and the like) in different formats. For example, and without limitation, a vertical view may display an events timeline while a horizontal view may display a 3D view of environment 107 with objects 106. In some embodiments, a smart phone app may be used to provide a user interface to the users and communicate with the system. For example, and without limitation, include interface may include displaying a 3D map, displaying camera feeds, specific configurations of system parameters (e.g., modes of operation) and status (e.g., malfunctions, SOC, component data, and the like), receiving system alerts or alarms, output audio streams, transmit audio streams, snap shots of alarm event, access to recorded video feeds, storage of events log, and the like.

In one or more embodiments, system 100 may include one or more audio modules 103 that are communicatively connected to computing device (e.g., processing unit 101) and each configured to provide audio data 124 associated with environment 107. Audio modules 103 may include speakers, microphones, indicators (e.g., LEDs and strobe lights), and the like. In various embodiments, sensors 118 may include audio modules 103. In one or more embodiments, audio modules 103 may include a plurality of audio modules. For example, audio modules 103 may include first audio module 103a, second audio module 103b, and third audio module 103c. In one or more embodiments, audio modules 103 may be configured to provide audio data 124 associated with environment 107. For example, first audio module 103a may be configured to capture first audio data 124a, second audio module 103b may be configured to capture second audio data 124b, and third audio module 103c may be configured to capture third audio data 124c. Audio data 124 may include an audio recording. Audio recording may include verbal content, where verbal content may include language-based communication. For example, verbal content may include one or more words spoken by an object 106 within environment 107. In other embodiments, audio data 124 may include sounds, such as sounds made by object 106 (e.g., shout, call, bark, alarm, and the like) or may include an ambient noise (e.g., thunderclap).

Still referring to FIG. 1A, sensors 118 may provide surveillance data 128 to computing device of system 100, which is communicatively connected to sensors 118. For example, plurality of imaging modules 102 may each be configured to provide image data 120 of environment 107, which includes body of water 114, to a processing unit 101, which is communicatively connected to imaging modules 102. Thus, processing unit 101 may be configured to receive image data 120 of environment 107 from each of the plurality of imaging modules 102. In another example, plurality of imaging modules 102 may each be configured to provide image data 120 and audio modules 103 may each be configured to provide audio data 124 to processing unit 101.

In one or more embodiments, image data 120 may include a visual representation of information. For instance, image data 120 may include a visual representation of environment 107. For example, image data 120 may include one or more images, videos, audio recording, or video stream of at least a portion of a scene (e.g., environment 107). Image data may be communicated by digital signals (e.g., sensor signals) using communicative connection. In one or more embodiments, image data 120 maybe compressed to optimize a transmission speed of image data (e.g., one or more photos or videos). For instance, image data may be compressed into a compression coding format (i.e. codec). Codecs may include MPEGs, H.26x codecs, VVCs, and the like. In one or more embodiments, image data and audio data may be stored in a database or memory 112, as discussed in this disclosure.

Still referring to FIG. 1A, computing device and/or processing unit 101 may be configured to identify one or more objects 106 within environment 107 based on surveillance data, such as image data 120 and audio data 124. Processing unit 101 may be configured to concurrently execute a plurality of neural networks, such as neural networks of FIGS. 3A and 3B. In one or more embodiments, identifying one or more objects 106 may include associating an object identifier 126 with each of the one or more objects 106. In various embodiments, object identifier may include data or information associated with an identity or attribute of object 106. In an exemplary embodiment, software for analyzing surveillance data, such as image data, may include software supporting “tripwire” features. For example, processing unit 101 may monitor movement of an object from one region to another region within environment 107. In one or more embodiments, processing unit 101 may support software that distinguishes types of objects, such as a person from an animal, as discussed further in this disclosure. In one or more embodiments, system 100 may include an image processing software. Surveillance data may be flagged or linked to other data, such as data stored in a database (e.g., object database of FIG. 3B).

In one or more embodiments, identifying an object may include, by processing unit 101, providing and/or determining an object identifier of object 106. For the purposes of this disclosure, an object identifier may include identification information associated with one or more object 106. In various embodiments, object identifier may be determined using a neural network detector (also referred to in this disclosure as a “detection neural network”) and/or neural network feature extractor (also referred to in this disclosure as a “extraction neural network”), as discussed further in FIGS. 3A and 3B. Identification information of object 106 may include recognizing a type of object, such as a person, animal, or inanimate object, that should be detected by processing unit 101. In various embodiments, a classifier may be implemented to categorize objects based on a type, as discussed further below. In one or more embodiments, processing of each of the software sub-system provide identification data of each object. Identification data may include present or past information related to object 106 and/or environment 107 and, further information may be added from the analysis of the complete status of all objects that are present within environment 107. Identification information may be continuously updated by processing unit 101 and used to alter the behavior and responses of system 100. Identification information may include, but is not limited to, a time of day, hours of operation of environment 107 (e.g., swim/play time opening hours of recreational area), a swimming skill level or proficiency of object 106 (e.g., person), an age of object 106, a name of object 106, a type of object (e.g., person, animal, inanimate object, and the like), medical condition risk of object 106, past culprit status of object 106 (e.g., object with history of being involved or instigating critical events), current behavior mode of system 100 or mode of operation (e.g., high alert mode, medium alert mode, and low alert mode), victim status (e.g., prior history of being involved in a but not the cause of a critical event), statistical model of historical behavior, and the like. Object identifier and/or identification information may be identified by system 100 using, for example surveillance data 128, may be recalled from a database, or may be manually inputted by a user using, for example, remote user device or an integrated interface (e.g., display) of system 100.

In one or more embodiments, convolutional neural network detector may be configured to identify objects 106 (e.g., people and animals of interest). Convolutional neural network detector may also be configured to determine if objects are fully submerged within body of water 114 if an object is partially submerged within body of water 114, or out of body of water 114. In exemplary embodiments, convolutional neural network detector may also be configured to identify the center contact point of each patron partially submerged in water, identify the head of the patrons, identify the robustness of the detection.

In one or more embodiments, convolutional neural network extractor may be configured to determine the age of an object, re-identify objects when they have been seen before by system 100, re-identify objects as the same person when they get occluded, and re-appear, and the like. In some embodiments, processing unit 101 may utilize deep neural networks to approximate the age of the people in the FOV of the imaging modules 102. In some embodiments, a behavior of system 100 may change according to the identity of each object, the age of each object, the context of the object's presence, the direct interactions with other objects, the movement style of the objects, the sound made by objects, the directives given by a responsible patron (e.g., user or supervisor). In some embodiments, each object or type of object may have a default status for their presence, which includes but is not limited to swimming skill level (e.g., swimming proficiency), age, identification, location, direction, speed, supervisory presence, active interactions, medical condition risk, and the like. The object identifier and/or status data of the object may be continuously updated, as described further below in this disclosure, by the system as information and data is gathered by the sub-systems (e.g., components) of system 100. In some embodiments, an output model of a feature extractor convolutional neural network may be stored in a database, such as an object database, so when the same objects return to environment 107, their swimming skill parameters (e.g., swimming proficiency) and other preferences can be retrieved and associated with them instead of system defaults.

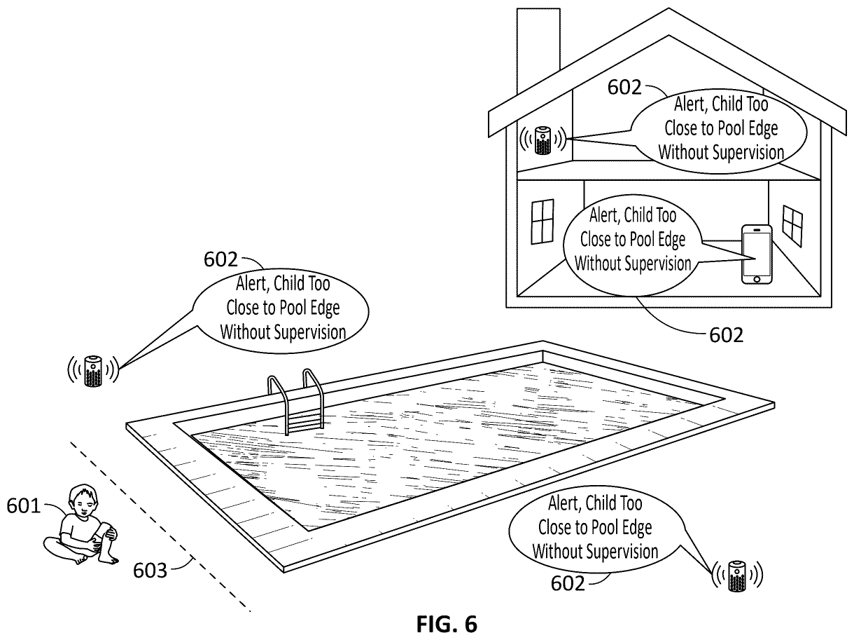

In one or more embodiments, convolutional neural network detector and/or extractor may be utilized to recognize specific gestures that are pre-determined to mean commands to the system, as discussed further in FIGS. 7A-7F. In some embodiments, system 100 recognizes hand command gestures by first recognizing a specific “key” hand gesture, then immediately followed by second gesture that represent the user command. Exemplary command gestures include, but are not limited to, thumbs up gesture, peace sign over the head, pointing up or down, time out sign. System 100 may monitor and identify specific hand gestures of individuals for instructions; although not limited to only those situations, the system accepts hand signals for the following reasons: relax its warning level limits, signal focused human attention and change the system behavior, trigger the system to start the identification process and personalize the system parameters.

As previously mentioned above in this disclosure, a classifier may be used to categorize objects based on type. In one or more embodiments, system 100 may generate a classifier using a classification algorithm, where classifier is implemented to sort inputs, such as surveillance data (e.g., image data, audio data, and the like), identifier data, and/or status data, into categories or bins of data. Classification may be executed using neural network classifiers but also for example, using logistic regression, quadratic classifiers, decision trees, naive Bayes classifiers, nearest neighbor classifiers, fisher's linear discriminant, learning vector quantization, boosted trees, random forest classifiers, and/or neural network-based classifiers, and the like. In one or more embodiments, one or more machine-learning models or neural networks described in this disclosure may use a classifier. Classifier may sort inputs into categories or bins of data, outputting the categories or bins of data and/or labels associated therewith. For example, classifier may be implemented to output data that labels or identifies a set of data, such that the set of data may be categorized into clusters. Processing unit 101 may be configured to generate classifier using a classification algorithm using training data. In a non-limiting exemplary embodiment of using a classifier, a classifier may be configured to aid in the determination of a level of a critical event, as discussed further below.

Still referring to FIG. 1A, computing device and/or processing unit 101 may be configured to determine a status data of one or more objects 106 based on at least image data 120 and object identifier 126. In one or more embodiments, status data 130 may be determined based on surveillance data 128 (e.g., image data 120 and/or audio data 124) and/or object identifier 126. Status data 130 may include information related to a current condition or state of object 106 and/or environment 107. Status data 130 may include, but is not limited to, a location of object 106 within environment 107, a location of object 106 relative to and/or in relation to body of water (e.g., distance from a set boundary or a physical edge of body of water), coordinates of environment 107, weather conditions near or within environment 107 (e.g., rain, fog, lightening, and the like), velocity of object 106 (e.g., falling or running by object 106), speed of object 106, use of a floating aid by object 106 (e.g., life vest, swim ring, paddle board, inflatable arm bands, pool noodle, inflatable recliner, and the like), sound made by object 106, inebriation status of object 106 (e.g., observed or manually inputted alcohol intake of object 106), current culprit status (e.g., object conducting dangerous behavior currently), underwater time (e.g., duration of time object 106 has been submerged below a surface of body of water), underwater movement characteristics of object (e.g., diving, swimming, thrashing, lack of movement, and the like), movement style of object (e.g., swimming, running, walking, and the like), overwater and/or underwater bobbing frequency, supervisory presence (e.g., direct contact supervision where a supervisor is within environment 107 or within a predetermined “safe” distance from object 106, distant supervision where a supervisor is near but outside of environment 107, not supervised where no supervisor is present within or near environment 107, number of supervisors present in environment or remotely, capability of supervisor where supervisor may be rated or identified as an experienced caregiver, moderate caregiver, or amateur caregiver), active interactions presence with one or more other objects within the environment, and the like.

In one or more embodiments, tracking neural networks may be used to determine status data of an object 106, as discussed further in FIGS. 3A and 3B. In some embodiments, a tracking process changes the order and weight of each level of its cascade matching algorithm, depending on the live situation, system status, and detection characteristics (e.g., data size, confidence level, location). In an exemplary embodiment, each patron's underwater time may be closely monitored using tracker output classification, and tabulated for consecutive time so warnings and alerts may be generated when individual patron's maximum times (e.g., thresholds) for various alerts levels are reached. In some embodiments of the present disclosure, processing unit 101 may be able to identify images that are of interest to improve the performance of system 100, and store them locally to eventually be communicated back to the factory for use in training or testing of new revisions of the neural networks and tracker.

In one or more embodiments, processing unit 101, or neural networks described in this disclosure, may be configured to recognize when objects are in dangerous situations, Exemplary embodiments, of dangerous situation include, but are not limited to, which being underwater for too long for the specific swimmer skill of each patron, approaching the pool edge safe area when the patron is known to be a non-swimmer, a patron running on wet pavements, a patron jumping or diving on another patron, a patron asking for help vocally, and the like.

In one or more embodiments, processing unit 101, and neural networks thereof, may be configured to recognize (e.g., determine) when objects are safe or out of dangerous situations (e.g., updated status data) so no false alarms are generated. Such examples exemplary situations include, but are not limited to, recognizing a patron re-surfacing above water before their specific dangerous time is exceeded, recognizing the presence of direct supervision to allow to relax the alarm conditions, recognizing the change in situation after a warning is transmitted, recognizing the command gestures of a patron to de-escalate an alarm condition, and the like.

Still referring to FIG. 1A, computing device and/or processing unit 101 may be configured to determine a critical event related to at least one of the objects 106 of the one or more objects based on status data 130 and a distress parameter 132. Critical event 134 may include a “dangerous” situation, occurrence, or event within environment 107 and involving object 106. A dangerous situation may include a life-threatening situation (e.g., an immediate danger) or a situation that could result in physical harm of object 106 (e.g., potential danger). If no critical event is determined, then a present situation is considered “safe”, where a safe situation refers to a situation where an object is not at risk of physical harm or experiencing a life-threatening or dangerous situation.

In one or more embodiments, distress parameter 132 may include a predetermined threshold (e.g., standard) of a status of object 106. For instance, distress parameter 132 may include an acceptable or desirable status data of object 106. In various embodiments, status data 130 may be compared to distress parameter 132 to determine critical event 134. Predetermined threshold may include one or more qualitative or quantitative values. For example, predetermined threshold may include a predetermined numerical value or range of values associated with a particular distress parameter. In a non-limiting exemplary embodiment, distress parameter may include a threshold, such as an acceptable predetermined duration of time that object 106 may remain submerged below a surface of body of water 114 without being harmed (e.g., acceptable amount of time for an object with similar object identifiers to hold their breath underwater). If status data is outside of the threshold of distress parameter, then processing unit 101 may determine a critical event (e.g., a dangerous event has, is, or will occur) based on the comparison between the status data and the distress parameter.

In one or more embodiments, distress parameter 132 may be retrieved from a database (e.g., private or public database) or may be manually inputted by a user of system 100. Distress parameter 132 may include various types of distress parameters. For instance, distress parameter 132 may include a supervisor proximity parameter, which may include a threshold distance between object and supervisor (e.g., a maximum distance or a range of distances object is allowed to be from supervisor). In another instance, distress parameter 132 may include a water proximity parameter, which may include a threshold distance between object and a body of water (e.g., a minimum distance object must maintain between object and body of water or a boundary of body of water that object must remain outside of). In another instance, distress parameter may include a movement parameter (e.g., threshold velocity, speed, thrashing, and the like of object). In another instance, distress parameter may include a weather parameter, which may include types of sounds, such as thunder, a threshold for environmental temperatures, a threshold for body of water temperatures, and the like. In another instance, distress parameter may include a volume parameter, which may include a threshold for decibels of one or more sounds or voices (e.g., a maximum volume of environment 107). In another instance, distress parameter may include a speech parameter, which may include predetermined words (e.g., keywords) associated with critical events and/or “dangerous” situations.

In one or more embodiments, status data may include a status of system 100 and/or components thereof. In some embodiments, system may periodically report a status of the efficiency of all components via a cloud network connection so a remote reliable cloud system can communicate warnings via cell phone messaging if there is an ineffectiveness of the pool protection. Although not limited to only those failures, examples include complete power loss, low battery condition of component, Wi-Fi loss, poor Wi-Fi connectivity, poor visibility, loss of communication with component, loss of speaker functionality, loss of microphone functionality.

Still referring to FIG. 1A, computing device and/or processing unit 101 may be configured to generate an alert based on the detection of the critical event. In various embodiments, an alert may include an audible alert, visual alert, any combination thereof or the like. Audible alerts may include noises, such as whistles, horns, chirps, and the like. In other embodiments, audible alerts may include verbal announcements or instructions. Verbal instructions may be outputted by system 100 in the form of attention-getting noises, such as whistle sounds mimicking the whistle of a lifeguard, followed by pre-recorded voice instructions. Non-limiting examples of vocal instruction outputs from the audio modules 103 may include, for example: “Tweeeeet! Toddler approaching the pool edge”, “Tweeeet! Tweeeet! Person underwater too long”, “Tweeeet!! Please walk, don't run on wet pavement”, and the like. Visual alert may include a visual indicator of a critical event. For instance, a visual alert may include a text message or notification shown on a display of system 100 and/or remote user device 136, strobing lights of system 100, flashing indicators of system 100, and the like. In some embodiments, alert may include an automated notification or automated voice message sent to a local authority, such as police or other emergency personnel.

In one or more embodiments, system 100 may include a display 140. Display may be an integrated component of system 100 or may include a display of remote user device 136. Display 140 may be communicatively connected to any other component of system 100, such as sensors (e.g., imaging modules and audio modules), processing unit, memory, and the like. In one or more embodiments, display 140 may be configured to show surveillance data, alert 138, and the like. Display 140 may provide graphical representations of one or more aspects of the present disclosure. For instance, a display view may be shown on display 140, where display view includes a visual or audio alert, a live video stream of environment 107, audio data from environment 107, visual representations and/or annotations, and the like. In some embodiments, an annotation may include a box or outline highlighting one or more object 106 so that a user may readily locate one or more objects 106 within a scene (e.g., environment 107). In other embodiments, visual representations may include text, such as text including object identifier, superimposed over a video stream of environment 107, where text may be position in, for example, a corner of display view or may track the movement of a corresponding object within environment. Display 140 may include, but is not limited to, a liquid crystal display (LCD), a plasma display, a light emitting diode (LED) display, a cathode ray tube (CRT), stereoscopic (3D) display, holographic display, head-up display (HUD), and the like. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

In one or more embodiments, display 140 may include and/or be communicatively connected to a user interface (UI) configured to at least receive a user input. In some embodiments, user interface may include a touchscreen display having a graphical user interface (GUI) that interacts with a website and/or application associated with system 100. In other embodiments, user interface may include a mouse, keyboard, switch, button, joystick, remote user device, mouse, any other input peripherals or composite user interfaces (CUIs), any combination thereof, and the like. In one or more embodiments, an application of system 100 may be configured to use the orientation of the host mobile device (e.g., remote user device) to change the format of displayed information for system 100. In one or more embodiments, the application (also referred to in this disclosure as an “app”) may be configured to use 3D graphics to illustrate the area of interest (e.g., environment 107) and the objects of interest (e.g., objects 106) within the area of interest. In one or more embodiments, the app may use smart icons to illustrate patrons of interest and changes its representation depending on the alert status of the patron.

User interface may be implemented as a display, a touch screen, a keyboard, a mouse, a joystick, a knob, a slider, and/or any other device capable of accepting user input and/or providing feedback to a user. In various embodiments, user interface may be adapted to provide user input (e.g., surveillance data, status data, object identifier, alerts, and the like) to other devices and/or components of system 100, such as processing unit 101. User interface may also be implemented with one or more logic devices that may be adapted to execute instructions, such as software instructions, implementing any of the various processes and/or methods described in this disclosure. For example, user interface may be adapted to form communication links, transmit and/or receive communications (e.g., sensor signals, control signals, sensor data, user input, and/or other information), determine various coordinate frames and/or orientations, determine parameters for one or more coordinate frame transformations, and/or perform coordinate frame transformations, and the like.

In one or more embodiments, user interface may be adapted to accept user input. For example, and without limitation, user interface may accept a user input (e.g., object identifier or status data) and user input may be transmitted to other devices and/or components of system 100 over one or more communication links. In various embodiments, user interface may be adapted to receive a sensor or control signal over communication links formed by one or more associated logic devices, for example, and display sensor and/or other information corresponding to the received sensor or control signal to a user. For example, a sensor signal may include surveillance data. More generally, user interface may be adapted to display surveillance data to a user, for example, and/or to transmit sensor information and/or user input to other user interfaces, sensors, or components of system 100, for instance, for display and/or further processing.

As previously mentioned, processing unit 101 may be implemented as any appropriate logic device. For example, and within limitation, processing unit may include a controller, processor, application specific integrated circuit (ASIC), processing device, microcontroller, field programmable gate array (FPGA), memory storage device, memory reader, and the like. Processing unit may be adapted to execute, store, and/or receive appropriate instructions such as software instructions from memory 112 implementing a control loop for controlling various operations of system 100. Such software instructions may also implement methods for processing sensor signals (e.g., surveillance data), providing user feedback (e.g., through user interface), generating alerts, querying devices for operational parameters (e.g., distress parameters), selecting operational parameters for devices (retrieving distress parameters from one or more databases), or performing any of the various operations described in this disclosure.

FIG. 1B is a schematic diagram showing an exemplary embodiment of physical components of system 100 in their targeted environment (e.g., environment 107). Target environment may include area of interest, such as environment 107. For instance, environment may include a backyard of a residence, which includes a pool 104 having one or more boundaries, as shown in FIG. 1B. In one or more exemplary embodiments, system 100 may include one or more processing units 101, imaging modules 102 (e.g., two imaging modules 102a and 102b), audio modules 103 (e.g., three audio modules 103a, 103b, and 103c), and the like. System 100 may be installed around environment 107, such as a home pool setting. Imaging modules 102a, b may be installed so that each imaging module may have full visibility of pool 104, but from different angles, as previously mentioned above in this disclosure. In one or more embodiments, audio modules 103a,b,c may be installed at various locations around pool 104 and at various locations in a corresponding residence, such as house 105, so there are no locations around house 105 where outputs of audio modules 103a,b,c cannot be heard by a user, such as a guardian or caregiver of object 106, owner of the residence, or supervisor of environment 107. Audio modules 103a,b,c may include one or more speakers with integrated microphones, as previously mentioned in this disclosure. In one or more embodiments, audio modules 103 may provide audio data to processing unit 101. Processing unit 101 may be located in an indoors, outdoors, or in a partially enclosed area where it may establish wireless communication with the other components of system 100 and/or remote components or modules communicatively connected to system 100, as previously discussed in this disclosure. In one or more embodiments, components of system 100 that are communicatively connected may communicate using a wired or wireless network. For instance, system may include a networking medium linking the components together. Networking medium may include a Wi-Fi or wired network.

In one or more exemplary embodiments, each imaging module may be positioned at a different location around environment such that each imaging module may provide a different angle of view of the same scene (e.g., environment 107). For example, each imaging module 102a,b may include corresponding field of view (FOV), such that imaging modules 102a,b may capture image data of environment 107 from different views to provide various perspectives of environment 107. Having various views, may allow for system 100 to monitor the entirety of environment 107 despite potential obstructions. For instance, if one imaging modules cannot capture image data of a portion of environment 107, then the other imaging module may provide supplemental image data of the obstructed portion of the area of interest. For example, if a portion of environment 107 is obstructed in a first FOV of first imaging module 102a so that first image data 120a does not include information regarding the portion of environment behind the obstruction, then second imaging module 102b may have a second field of view that provides second image data 120b including the otherwise obscured portion of environment 107. In another exemplary embodiment, each imaging module (e.g., camera) may provide the same view, and thus redundant images and/or videos, of environment 107 may be provided to processing unit 101. For example, imaging modules 102a-b may capture a video of at least a portion of environment 107 from the same view so that, in case one imaging module 102a,b malfunctions or becomes inoperative, the other imaging module 102b,a may provide image data to ensure that at least a portion of environment 107 is being actively monitored at all times.

In one or more exemplary embodiments, imaging modules 102a,b, audio modules 103a,b,c, and processing unit 101 may be communicatively connected. Imaging modules 102a,b, audio modules 103a,b,c, and processing unit 101 may communicate constantly using a dedicated Wi-Fi connection that is created from processing unit 101. Imaging modules 102a,b and audio modules 103a,b,c, may communicate directly with processing unit 101. Networking router may be used to link the various components of system 100, such as imaging modules, audio modules, processing unit and the like, together. Processing unit 101 algorithms, Wi-Fi router communication capability, Wi-Fi streaming images from imaging modules 102a,b, the Wi-Fi streaming from the audio modules' speakers and audio modules 103a,b,c, all together enable functions of system 100. The Wi-Fi functionality may be accomplished using a Wi-Fi router that provides standard functionality and an Access Point Client mode so it can appear to an existing Wi-Fi network as a normal Wi-Fi client and access its services. Alternatively, the Wi-Fi router may connect to an existing Wi-Fi network router using a wired connection. Imaging modules 102a,b and audio modules 103A, 103B, 103C will only be routed to processing unit 101, but processing unit 101 may get access to the Internet by being a client to a router that has access to the Internet.

In one or more exemplary embodiments, imaging modules 102a,b may be constantly Wi-Fi streaming video to processing unit 101. The location of each of imaging modules 102a,b around environment 107, such as pool 104, are such that the angle of view of each camera (e.g., imaging modules 102a,b) complement the other imaging modules 102a,b in the sense that they both have visibility of an object 106, but from significantly different angles. Object 106 may include, but is not limited to, a person (e.g., a child or an adult), an animal (e.g., a pet or wildlife), an inanimate object of interest, or the like. In an exemplary embodiment, when one imaging module, such as first imaging module 102a, includes a view of the front of object 106, such as a person, the other imaging module, such as imaging module 102b, is located such that the second imaging module has visibility of the side or back of the same object 106. This strategy enables system 100 to use the information of both imaging modules 102a,b to solidify the detection and classification analysis of all image data. The algorithm to determine the location in three dimensions of the classified objects may also utilize the information of two or more imaging modules 102a,b to provide the highest accuracy, as discussed further below in this disclosure.

In one or more embodiments, imaging modules 102a,b may include infrared and/or visible spectrum illuminators, as previously mentioned in this disclosure, so images and/or videos can be captured in low-light environments. In various embodiments, imaging modules 102a,b may be powered by a power source. For instance, one or more of imaging modules 102a,b may be in electrical communication with one or more solar panels and/or batteries. Powering imaging modules 102 using solar panels may provide a cost-efficient and scalable system 100. Furthermore, powering imaging modules 102 using battery assemblies may allow for case of installation of system 100, specifically imaging modules 102. In one or more embodiments, imaging modules 102 may incorporate a low-power mode to enable longer run time during specific times of day, such as at night, when there is less activity in the environment. In some embodiments, while operating in a low-power mode, imaging modules 102 may send less frames per second and/or send frames of reduced pixel density.

In one or more embodiments, audio modules 103, may be distributed around pool 104 and house 105, so that audible alerts from audio modules 103 can be heard by desired responsible parties. As understood by one of ordinary skill in the art, though exemplary embodiments describe system 100 having three audio modules 103a,b,c, system 100 may include any number of audio modules. In one or more embodiments, audio modules 103 may receive audio streams from processing unit 101 to play. In other embodiments, audio modules 103 may receive from processing unit 101 short commands to play pre-recorded and locally stored audio files. In various embodiments, audio modules 103 may also include a visual indicator, such as a bright light, that may be strobed to indicate a critical event, as described further below in this disclosure. Audio modules 103 may include battery operation and have the capability to self-determine if there is a loss in connectivity between audio modules and processing unit 101 so audio modules can independently indicate to a user that the audio modules are malfunctioning or inoperative and thus unable to indicate any warning of danger, such as a critical event.

In one or more embodiments, audio modules 103 may provide audio data. For instance, audio modules 103 may include microphones that receive environmental audio (e.g., noises or verbal sounds), and transmit back the captured audio to processing unit 101. Processing unit 101 may then analyze the received audio data from audio modules 103. For instance, processing unit may analyze the received audio data to recognize key words like “help”, “connect intercom to the pool”, “intercom off”, “stream in pool side audio”. The interpretation of the sounds of the audio data, using neural network processing, may be used as information to generate alarms or change the system operating parameters, as discussed further in this disclosure. The combination of the microphone and speaker of one or more audio modules 103a,b,c may enable processing unit 101 to offer value-added functionality. For instance, sounds from environment 107, such as pool 104, may be captured by one or more outside audio modules, such as second audio module 103b and third audio module 103c, and streamed to one or more interior audio modules, such as first audio modules 103a, so a caretaker can listen to the activities within or near the environment, such as by pool 104. For example, a mother can listen and hear if her children are calling using communicative connected audio modules 103a,b,c. In one or more embodiments, remotely located audio modules, such as first audio module 103a, can similarly be connected to pool audio modules, such as second audio modules 103b,c, to form bidirectional communication between the audio modules. This functionality enables a caretaker to give instructions or ask questions from, for example, first audio module 103a, to objects 106 at the pool 104, who can hear and respond using second audio module 103b and/or third audio module 103c, respectively. For example, using this intercom functionality, a mother could ask her children to come out of the pool for lunch. Additional value-added functionality of the microphone and speaker combination of audio modules 103a,b,c may be to provide monitoring of system 100 functionality. Being part of a life-saving device, health monitoring of system 100 is critical. A test signal output from speakers of audio modules 103a,b,c and captured by the microphones of audio modules 103a,b,c for analysis provides feedback for verifying functionality of system 100. In one or more embodiments, audio modules 103 may be configured to provide a two-way intercom functionality, where an individual at one audio module may communicate with a person located at another audio module using the speakers and microphones of audio modules 103.

In one or more embodiment, audio module 103 may be configured to autonomously generate verbal announcements if audio module 103 loses communication with processing unit 101. Audio module may be configured to receive all audio output commands from the computing unit (e.g., processing unit 101), so if communication with the computing unit is lost, the speaker could not execute its life-saving audio warning function. The audio module, thus, incorporates the ability to self-recognize a loss in communication with its controlling units (e.g., processing unit 101) and output audio warnings that informs users that the system is compromised. For example, an audio warning generated by one or more audio module may include “no lifeguard on duty.” In some embodiments, system 100 may output human voice recordings via speakers to provide directives and information to an environment (e.g., a pool area) and anywhere the speakers are located. Examples include, but are not limited to: “stop running please”, “toddler approaching the pool”, “person underwear for too long”, “please move the obstacle, I can't see”, “please all check in, I can't see Zach”. In some embodiments, audio modules can be used to provide an intercom functionality where real time audio streams are passed at both ends points (e.g., between speakers and microphones). The end points may include selected audio modules and/or a remote user device.

In some embodiments, system 100 may interface with external sensors to complement and/or supplement system functionality and capabilities. Although not limited to this list, examples include interfacing with floating sensors, interfacing with underwater cameras, interfacing with Smart Speakers, interfacing with home security system components like door latches and motion detectors, and the like.

In one or more embodiments, processing unit 101 may be configured to interface with other external complimentary systems and/or sensors to provide further inputs to identify a situation (e.g., critical event) and the correct action (e.g., alert).

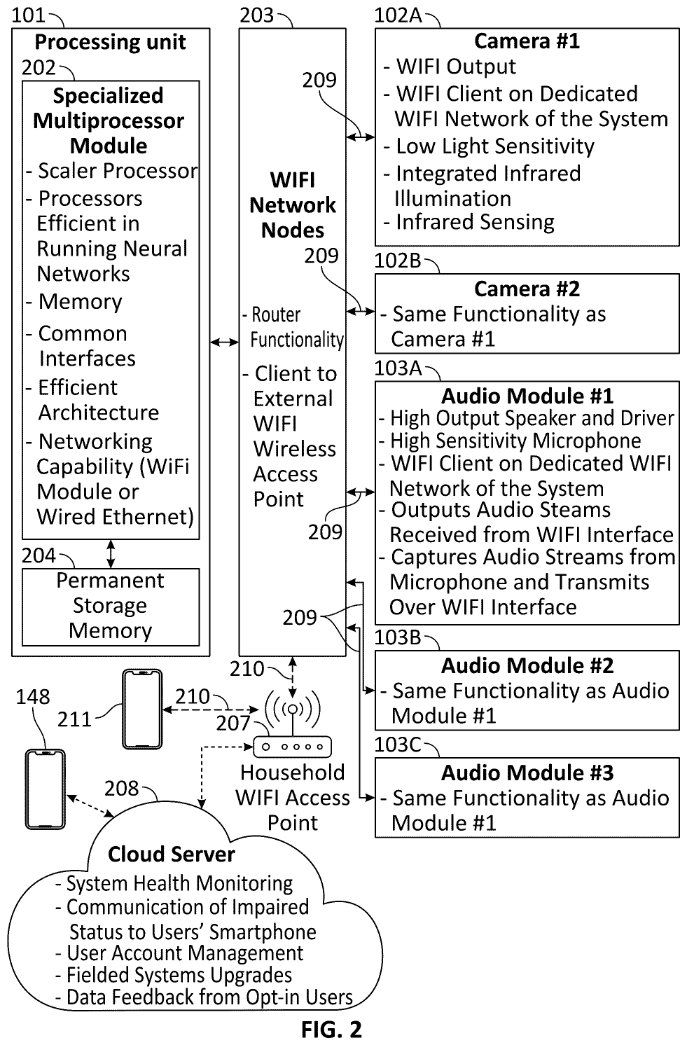

In one or more embodiments, water surveillance system 100 may include various modes of operations (also referred to in this disclosure as “modes”). Modes of operation may include a setting for a specific purpose for system, where mode of operation may be selected by a user (e.g., supervisor). For instance, a first mode of operation of system 100 may include a surveillance mode of operation, where system is configured to monitor an environment for any critical events (e.g., dangerous or life-threatening situations). In one or more embodiments, critical events may be categorized into various levels. For instance, critical event may include a low-level, medium-level, or high-level critical event. In one or more embodiments, a low-level critical event may include a situation that requires the attention of a user and/or supervisor. A low-level alert may be generated in response to a determination or detection of a low-level critical event. In non-limiting exemplary embodiments, low-level critical event may include a low state of charge (SOC) of a power source of one or more components of system, a malfunctioning component of system, a weather condition, an unapproved or unidentified object breeching a perimeter or fencing of environment, an object running on wet pavement, an object jumping or diving on another object, and the like. In one or more embodiments, a medium-level critical event may include a highly-likely or imminent danger. In non-limiting exemplary embodiments, a medium-level critical event may include an object breaching a boundary or exceeding a proximity threshold, and the like. In one or more embodiments, a high-level critical event may include a current or immediate danger or life-threatening situation that requires immediate attention or response from a user and/or supervisor. In non-limiting exemplary embodiments, a high-level critical event may include an object currently drowning (e.g., thrashing in a pool or submerged for more than a predetermined duration of time), an object verbally asking for help or saying keywords, a non-swimmer object approaching a body of water when no supervisor is present in environment, and the like. In one or more embodiments, a user may manually select which types of critical events are considered low-level, medium-level, or high-level critical events. In one or more embodiments, a user may also select the type or level of alert generated in response to a particular critical event or a level of critical events. In other embodiments, a manufacture of system may select categorization of types of critical events or associated alerts. In one or more embodiments, processing unit is configured to report a functionality status to the system's cloud server (shown in FIG. 2) to enable the always-up cloud server to alert responsible parties if system is compromised (e.g., malfunctioning components, low SOC of one or more components, security breach or access to system by an unauthorized party, and the like).

In some exemplary embodiments, the behavior of the system changes according to the user-selected mode of operation. Some exemplary modes of operation for surveillance may include non-pool-time mode (or setting), pool-time mode, out-of-season mode, good-swimmers-only mode, and the like are some examples of selectable modes of operation of the system that changes the responses.

As updated status data is received by processing unit, a critical event, and level of alert may alter. For example, a medium-level critical event may be determined if an object approaches a body of water Processing unit may then receive updated status data that determines the object has entered the body of water and the critical event may increase to a high-level critical event based on the updated status data, thus increasing the level of the alert from a medium-level alert (e.g., verbal announcement) to a high-level alert (e.g., whistle blowing or siren in addition to verbal announcement and messages on a mobile device).

In other embodiments, a second mode of operation may include a gamification mode of operation, where system is configured to provide one or more types of interactive activities or games for user and/or objects within environment. For example, gamification mode of operation may include gamification of system functionality by using one or more system components to enable a user to play a game, such as, but not limited to, Simon says, red-light-green-light, race coordination, and other games. Gamification mode of operation may also include other general water activities such as water aerobics, racing, and the like. In another instance, system 100 may include an entertainment mode of operation. Entertainment mode of operation may include playing music over audio modules, having a phone call function, and the like.

In one or more embodiments, system 100 may include a security mode of operation. For example, and without limitation, system may include complete backyard security that includes virtual fence definition (e.g., predetermined boundaries as discussed in this disclosure), intruder-alert functionality (e.g., detecting if an unknown and/or unidentified object has entered environment), and the like.

In some exemplary embodiments, a user command by a user may initiate or change a specific mode of operation of system 100. User command may include a command gestures (as shown in FIGS. 7A-7F), verbal commands (e.g., commands received by a microphone of system), or inputted commands (e.g., commands inputted into user system using user interface, such as a selection from a drop-down menu or from a list of options). In other exemplary embodiments, certain user commands may adjust mode of operation of system, such as change in the type of game being played during a gamification mode of operation, types of critical events being monitored by system (e.g., only high-level critical events generate alerts), or an alteration of one or more distress parameters (e.g., the duration of time for an object to remain submerged without generating an alert may be changed by a user command as discussed further in FIGS. 7A-7F).

In one or more embodiments, system 100 may provide long-term storage of video and sound, event browsing of recorded videos, anomaly detection. two-way intercom functionality. wherein the program incorporates additional value-added functionality to make the system even more useful to users, gamification of the system functionality, using all the system components enable the user to play Simon says, red-light-green-light, race coordination, and other games. complete backyard security is provided with virtual fence definition, intruder-alert functionality, long-term storage of video and sound, event browsing of recorded videos, anomaly detection. two-way intercom functionality.

Now referring to FIG. 2, a block diagram of an exemplary embodiment of a communication interface of system 100 is illustrated. In one or more embodiments, processing unit 101 may include computing power and memory sufficient to run multiple algorithms concurrently using a specialized multi-processor module 202. Specialized multi-processor module may include, for example, a plurality of scalar processors, specialty processing units, and memory architecture to concurrently run multiple neural networks. In one or more embodiments, specialized multi-processor module may efficiently process surveillance data, such as image data or audio data, by implementing one or more neural networks. Processing unit may be communicatively connected to memory 112, which may include, for example, a permanent storage memory 204.

In one or more embodiments, system 100 may include Wi-Fi network nodes 203 that enable the creation of a dedicated communication path 209 between processing unit 101, imaging modules 102, audio modules 103, and also communicates with an externally provided Wi-Fi router 207 (e.g., household Wi-Fi access point). Wi-Fi network nodes 203 may include router functionality, a client to external Wi-Fi wireless access point, and the like. In various embodiments, Wi-Fi network may be the only network that imaging modules 102 and audio modules 103 communicate with, where system 100 may be configured to automatically start a connection between system components (e.g., imaging modules, audio modules, and the like) and processing unit 101 upon power up. Each system component may, thus, have a point-to-point connection with processing unit 101. In one or more embodiments, processing unit 101 may also connect to the Wi-Fi router using Wi-Fi 209. A dedicated Wi-Fi router may be configured to connect to a pre-existing independent Wi-Fi network 210 that is created from an external Wi-Fi access point and router 207 (e.g., wired or wirelessly).

In one or more embodiments, a smart phone app 211 may be used in conjunction with system 100 to provide diverse functionality, where one of those functions is to enable to configure the processing unit 101 to connect to a communication network, such as a home Wi-Fi. Home Wi-Fi is one connectivity path to the greater Internet where the guardian system server (e.g., a cloud server 208) can be accessed. Processing unit 101 may also incorporate a cell phone module so the internet may be accessed using a physical port.

In one or more embodiments, cloud server 208 of system 100 may provide administrative functionality to the deployed systems. In life-saving functionality, the health of system 100 and corresponding components need to be monitored and communicated if compromised. Processing unit 101 may periodically monitor the quality of system components and report the status of system 100 (or lack thereof) to cloud server 208. Cloud server 208 may then provide an update to a user through app 211 to, for example, remote user device 148, which may include key information. All compromised features are reported and communicated. Although not limited to these, examples may include a power outage of the system, nonfunctional camera, poor Wi-Fi connection, an obstructed camera, a blinded camera, a low contrast image, a low battery condition of component, a loss of communication with component, a loss of speaker functionality, a loss of microphone functionality, and the like. Cloud server 208 may also be used to allow for health monitoring of system 100, updates n communication impairment statuses to a remote user device, user account management, fielded system upgrades, data feedback from opt-in users, and the like.

In one or more embodiments, system cloud server 208 may provide other administrative functionally, such as, for example, user account management, upgrades to fielded system software, and retrieving data from permanent storage memory 204 of fielded system when available and allowed. System cloud server also assists in the execution of the 3D construction scene process.

Now referring to FIGS. 3A and 3B, flow charts of various methods of operation of system 100 are shown. As shown in FIG. 3A, a flow chart of an exemplary embodiment of a method 300 of monitoring an environment using system 100 is provided. In one or more embodiments, surveillance data, such as image data 120 and/or audio data 124 may be received by processing unit 101 (shown in FIGS. 1A and 1B). For instance, one or more sensors 118 of system 100 may collect information associated with a scene, such as environment 107, body of water 114, and one or more objects 106 and generate surveillance data based on detected environmental phenomenon in the scene, such as movements of one or more persons or animals, an ambient temperature, a temperature of body of water 114, environmental weather, and the like. Surveillance data may include various types and formats of information, such as images, video recordings, streaming videos, sound bites, qualitative and quantitative values and/or measurements, and the like. For example, surveillance data may include image data 120, environmental data (e.g., humidity, temperature, and pressure measurements), audio data (e.g., decibel measurements, verbal content, and sounds), and the like.

As shown in step 301 of method 300, method 300 includes receiving, by processing unit 101, image data 120 (e.g., video images 301a,b) of environment 107 from each of the plurality of imaging modules 102. More specifically, a neural network detector of processing unit 101 may receive video images 301a,b. Image data 120 may include real time video images 301a,b received from, for example, one or more sensors, such as, for example, a first imaging module 102a and/or a second imaging module 102b, respectively.

As shown in step 302 of method 300, method 300 includes detecting, using neural network detector, one or more objects, such as object 106, within environment 107 based on received video images 301a,b. In one or more embodiments, processing unit 101 may be configured to identify one or more objects within environment 107 and generate a corresponding output.

As shown in step 303 of method 300, additional information and/or data associated with detected objects 106 may be retrieved or provided by neural network feature extractor. For example, and without limitation, neural network feature extractor may be used to provide an object identifier of object 106 and/or to determine status data of object 106. Neural network feature extractor may include an algorithm configured to execute a different architecture of convolutional neural networks to extract different details about object 106. For example, if a person is the object of interest, the object identifier may include information such as an age, identification (e.g., name) or previous/historical object identifiers (e.g., information from previous recordings), and registration (e.g., user input or retrieval from a communicatively connected database), “person-seen-before-today” indication, and the like.

In one or more embodiments, processing unit 101 may be configured to store an identity of a patron with all their identification features or attributes and skill information (e.g., non-swimmer, proficient swimmer, and the like) when user-requested, and when there is sufficient information that has been determined. In one or more embodiments, processing unit 101 may be configured to identify that there is an obstruction preventing imaging modules (e.g., cameras) from having a clear view of the pool when too much (e.g., a predetermined percentage) of the pool edges can no longer be seen within a scene for a period of time by running a segmentation convolutional neural network and comparing the results with stored calibration results, and other results in time.

In one or more embodiments, system 100 may be able to automatically recognize images that neural network feature extractor struggled to classify with a high confidence level, and store such images locally (e.g., memory 112 of FIGS. 1A and/or object database). In some embodiments, surveillance data 128, such as image data 120 (e.g., images) or audio data 124, may be communicated back to a factory of manufacture for use in training or testing new revisions of neural network. A data agent algorithm may utilize tracker information and neural network confidence metrics to selectively capture consecutive images where objects are known to be present, but where the neural network confidence level is considered low. Those images may be useful to be added in the neural network development cycle for iterative learning purposes. After user permission has been granted, system 100 may periodically communicate with a system server to send back images that have been captured by system 100. System server may then securely manage the images as required by the development process.

As shown in step 304 of method 300, method 300 includes 3D tracking of objects within environment 107 using, for example, a tracking model (also referred to in this disclosure as a “3D tracker” or a “tracking neural network”). In one or more embodiments, processing unit may calculate the location in three-dimensional space of each object and utilize such information in the tracking algorithm. In other embodiments, processing unit 101 may incorporate motion prediction algorithms and utilizes information (e.g., outputs) from motion prediction algorithms for tracking algorithm. Data related to the detection and identification of the one or more objects by processing unit 101, such as neural network detector and extractor, may be used to track the one or more objects 106 within environment 107. In some embodiments, calibration information may also be used, as discussed further below in this disclosure, to track one or more objects. In one or more embodiments, tracking model may run various algorithms to repeatably identify the same one or more objects from video frame to video frame. Algorithms in of tracking model may include, but are not limited to, elements of Observation-Centric SORT, DEEP SORT, SMILEtrack, Kalman filtering, cascade matching, track management, two-dimensional (2D) to 3D back projection, and logical state machines to create the system behavior using all the information available. An output at this point of method 300, and thus the output of tracking model, may include a 3D coordinate system or bird's eye view of environment 107 (e.g., pool 104), with all the objects of interest (e.g., objects 106) correctly located in the coordinate system. For example, and without limitation, output of tracking model may include status data, which includes information related to a current condition of object 106 and/or location of object within environment 107. In some embodiments, processing unit may implement an elaborate 3D tracker of patrons (e.g., objects 106) that reports the location in 3D space of each patron, and the status of each track's robustness. None or more embodiments, 3D tracker may be configured to utilize information from all sensors, multiple neural networks described in this disclosure, location in 3D space, motion estimation information, historical and statistical patrons' information, to robustly locate all patrons in the field of views of any sensor. In one or more embodiments, processing unit 101 may use deep convolutional neural networks to process individual images to locate and classify objects, such as people, animals, or inanimate objects. In some embodiments of the present disclosure, processing unit 101 may utilize deep neural network detector to determine if a patron is underwater, partially submerged, or over-water, locate a head of the patron, locate a body of the patron, locate a water contact point or location, and identify communicating gesture signals of objects or supervisors. In some exemplary embodiments, processing unit 101 may receive images of a minimum of two cameras and use the extracted information for tracking algorithm (e.g., tracking neural network). In some embodiments, processing unit 101 may utilize deep convolutional neural network feature extractors on each object in the tracking algorithm to learn to distinguish individual persons (e.g., identify object identifiers). For example, object identifiers of a person may include the person's age, specific identification, and re-identification after being obstructed may be determined using neural network feature extractor.

As shown in step 305 of method 300, method 300 includes determining, by processing unit 101, a context and status update of the one or more objects 106. Context and status update may be based on, for example, status data 130 and distress parameter 132. For example, and without limitation, object identifier 126 may include information indicating that object 106 is a non-swimmer, and images 301a,b may include a video stream showing object 106 a current distance x from an edge of body of water 114 (e.g., pool 104), where distance x is less than distress parameter, which is a distance y. In response, status update includes a critical event being determined.

In one or more embodiments, the performance of convolutional neural networks (CNN) improves when there are more real pixels to process. System 100 may utilize imaging modules with very dense arrays (e.g., 8K×8K). In some embodiments, processing such a high number of pixels may be costly for processing, thus, system 100 (e.g., processing unit 101) may scale image data (e.g., one or more images or videos) down to be processed more efficiently. In other embodiments, system 100 may crop one or more portions of original image data (e.g., original one or more images or videos captured by imaging modules), preserving all pixels in within areas of interest, such as where objects are estimated as being located far away from the camera, or small. Such a process enables optimization of the performance of the convolutional neural networks and the processing bandwidth. System 100 may also use a digital zoom functionality with larger camera arrays to provide desirable framing and pixel count although cameras may be installed at substantial distances from environment. For instance, cameras with large pixel density and digital zoom functionality may be used to obtain the proper framing of the area of interest (e.g., environment) and proper pixels-on-target count to compensate for various positions of the camera at installation.

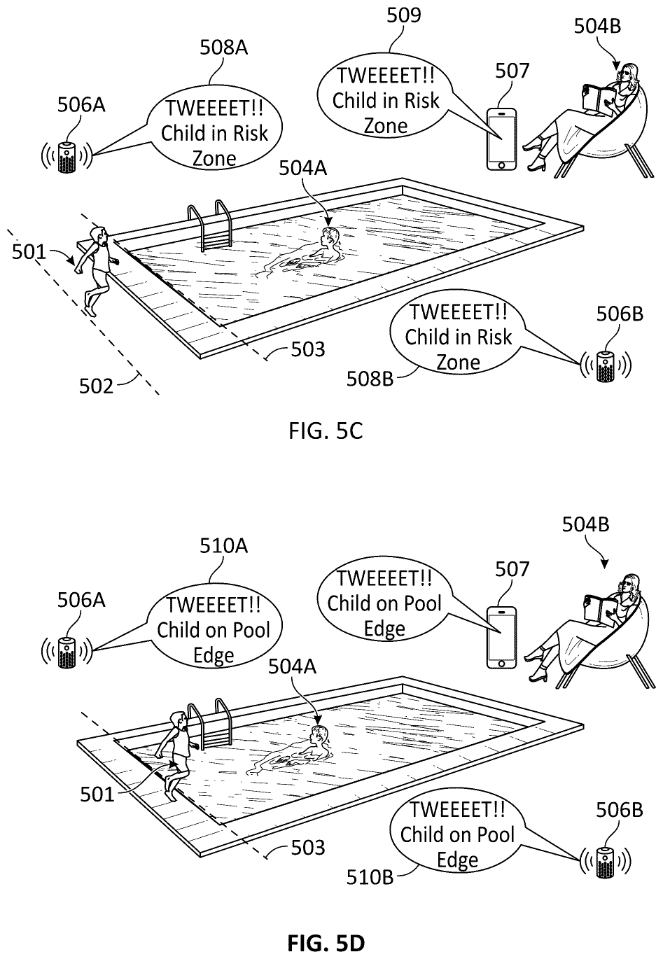

At this point of the system processing, all objects are solidly identified and located within environment 107. Next, as shown at step 305, processing unit 101 uses known information in context and determines a course of action based on status data (e.g., status updates) and object identifier. Knowing the location and detailed information (e.g., identifier information) of each object may allow system 100 to dictate different actions. For example, a toddler that is by a pool alone and unsupervised may generate a different system behavior than the same toddler that is by the pool jumping in the arms of a guardian, as discussed further below in FIGS. 5A-12.

In one or more embodiments, there may be instances where objects (e.g., patrons) enter a scene (e.g., environment 107) for the first time, instances where objects maybe be seen well from both imaging modules, instances where objects may be seen only from one imaging module, instances where objects get occluded from both cameras and need to be found again. As a result, tracking algorithm of system 100 may be dynamically configured for each type of scenario such that each configuration is optimized to stabilize the tracking of the object based on the type of specific situation.

As shown in step 306 of method 300, method 300 includes generating, by processing unit 101, an alert based on the detection of critical event 134. In one or more embodiments, processing unit 101 may determine a critical event related to at least one of objects 106 of the one or more objects based on status data 130 and distress parameter 132. Continuing the non-limiting exemplary embodiment discussed above, object identifier may include information labeling object as a “non-swimmer” and “toddler”, and status data may include that object is a distance x from edge of body of water according to current image data (e.g., live video stream). Processing unit may provide distress parameter based on at least object identifier, where providing distress parameter may include, but is not limited to, retrieving distress parameter from a database and/or prompting a user to manually input or select distress parameter after identifying one or more objects in environment. Distress parameter may include a water proximity parameter having a predetermined distance y (e.g., boundary about body of water 114) from body of water 114. Distance y may include a threshold distance, where object must maintain at least distance y from any edges of body of water to be considered “safe.” Thus, if distance x is greater than distance y, then processing unit will determine that there is no critical event associated with object based on water proximity parameter and status data. If distance x is less than distance y, processing unit will determine there is a critical event based on water proximity parameter and status data. In response, processing unit will generate an alert notifying a user that object is in danger (e.g., experiencing or at risk of experiencing a dangerous situation) of breaching a boundary and being too close to body of water. Distress parameter may include an event and/or threshold. An alert and/or warnings may be generated when an object of a particular status triggers the event or exceeds a predetermined threshold. Although not limited to this list, distress parameters may include events such as an object outside safe distance from a pool edge and not getting closer, an object outside safe distance from pool edge but moving closer, patron breach of safe distance from pool edge, object at pool edge, object in water, object underwater (i.e. fully submerged) but under maximum allowed time, object underwater above maximum allowed time, obstruction in field of view of one or more imaging modules, abnormal behavior of object (may be due to medical condition, inebriation, or other), dangerous behavior (may be running on wet pavement, jumping in shallow water, jumping on other patron, excessive splashing on other patron, patron hitting another, patron holding another underwater), the word “help” being captured by audio modules, and the like. In various embodiments, processing unit may take into consideration a plurality of sets of status data and a plurality of distress parameters to determine critical event. In one or more embodiments, each set of status data and each distress parameter may be assigned a weight to rank importance and significance of each set of status data compared to the plurality of sets of status data and each distress parameter to the plurality of distress parameters.

In one or more embodiments, system 100 may generate alert 138 at various alarm levels. Not all alarm levels may aim at communicating an immediate dying emergency. For example, an alert may be low level alarm of warning that may include, for example, informative spoken messages. In another example, an alert may include a medium level alert that includes a jarring sound. In another example, an alert may include a high alarm level that include continuously, high-volume sounds and verbal warnings. Any alarm level of an alert may include visual warnings (e.g., flashing lights or messages on the screen of a mobile device), audio warnings at various volumes and frequencies of occurrence (e.g., verbal warnings from audio modules or loud sounds), and the like. The system may recognize situations early and generate informative messages to escalate or de-escalate a critical event depending on whether the critical event has been addressed or resolved by a user (e.g., supervisor). As with a human lifeguard, system 100 may expect a response by a detected object or supervisor to the alerts it communicates in the form of some physical behavior change in the risk area by one or more detected objects. Although not limited to this list, examples of responsive actions may include a patron may swim back up from underwater, a bystander may take action to assist a patron in peril, a patron may change direction and not move further toward the pool edge, an obstruction may be removed, a patron may reappear after being occluded, a caregiver may gesture the system and deescalate the alert, a caregiver may gesture the system and command a relaxation of the alert parameters, a message may be received from the system app to deescalate the alert, a patron may stop the risky behavior that caused the alert, and the like. In one or more embodiments, processing unit 101 may be configured to output several levels of alert (e.g., warnings), each aimed at clearly informing the responsible parties (e.g., supervisors) of the severity of the situation as previously mentioned in this disclosure. The warnings may be communicated by processing unit 101 using natural human communication voice, and sounds, and electronic messages that are proportional to the alert condition.

In some embodiments of the present disclosure, system 100 utilizes speakers of audio modules 103 to output high pitch loud alarm sounds that are appropriate to the warning and alarm level. Examples include, but are not limited to, a quick chirp from a lifeguard whistle, an insisting chirp from a lifeguard whistle, repeated whistling, person shouting ‘alarm’, smoke-alarm pitch alarm, car-alarm pitch alarm. The alarm sounds that are generated may be of infinite variety as they are recording clips that stored locally and get streamed to the audio modules of the system. Audio clips may be of high quality. The system contains various alert sounds and voice recording that may get concatenated together into an attention getter sound and informative human message. The transmitted messages are selected specifically for the alert that may be detected. Although not limited to this list, examples of alert sounds may include tweet (lifeguard short whistle blast sound), voice of: “don't run on wet pavement”, tweet (lifeguard strong insisting attention getting whistle blast sound), voice of: “child by pool edge”, “tweet (lifeguard strong alert whistle blast sound), voice of: “child underwater” (repeating), a voice stating “warning, child alone by the pool”, beep (piecing fire alarm-like sound), repletion of any sounds or verbal instructions or warnings, and the like.

As shown in step 307 of method 300, method 300 may include generating an audio stream. Alerts and warnings that system 100 may generate may be very diverse as they are formed by practically a limitless number of audio pre-recordings of high-quality audio files that may be concatenated together. As a real human lifeguard, system 100 may use recordings of high-pitch, high volume whistle sound to get a patron's attention, followed by voice directives. As another example, system 100 may repeat high pitch whistle blasts to signal a strong alert condition and force a response from someone. In some cases, the system may attempt to shock a toddler with a loud high pitch sounds so he/she may stop and cease any dangerous or potentially dangerous activity. As shown in step 308 of method 300, method 300 may additionally and/or alternatively generate a message to a portable device (e.g., remote user device). For example, system 100 may send smart phone messages to devices registered with system 100. In some embodiments, messages may contain only text. In other embodiments, messages may include messages and alert sounds. In other embodiments, messages may include real time image data showing footage of environment 107. Real time image data shown on a display of system 100 or remote user device may include visual representations or annotations, such as annotations signaling or indicating the object on danger or a potentially dangerous situation, as previously discussed in FIGS. 1A and 1B.

In one or more exemplary embodiments, system has different behavior depending on the status of each object (e.g., a patron), as mentioned in step 305. A patron identified as a good swimmer may not trigger any alert when they approach the pool unsupervised, where patron identified as a non-swimmer toddler would trigger warnings and alerts. The system may always recognize and identify all the possible danger situations for every patron, but depending on some status elements of each person, some danger situation may be deemed not risky, and no alerts may be generated. In one or more embodiments, system may contain a state machine that dictates the behavior of its alert outputs. The state machine logic is the same for every patron, but the status information dictates the flow through the state logic and, thus, the resulting response.

As shown in FIG. 3B, an exemplary embodiment of a method 320 of processing surveillance data is provided. Processing surveillance data may include identifying an object (e.g., providing an object identifier), determining a status data, determining a critical event, any combination thereof, and the like. In one or more embodiments, processing unit 101 may process surveillance data 128 from sensors 118 (e.g., image data from imaging modules and audio data from audio modules). As previously mentioned in FIG. 3A, step 302 includes neural network detector detecting and/or identifying one or more objects 106 withing environment 107. Neural network detector may transmit information about object and/or environment to object database for storage, later retrieval by processing unit, or for feedback purposes (e.g., iteratively training neural network detector based on previous and/or historical inputs and outputs).

In one or more embodiments, processing unit 101 may be configured to crop partial images from original pre-downsized larger size images to use all the available pixels and make accurate predictions using convolutional neural networks.

As shown in step 303, and as previously mentioned in FIG. 3A, for each detected object reported above a configurable threshold of neural network confidence level, neural network feature extractor may execute an extraction of an identification of object and update object database 318. Neural network extractor may transmit information about object and/or environment to object database for storage, later retrieval by processing unit, or for feedback purposes (e.g., iteratively training neural network extractor based on previous inputs and outputs). In one or more embodiments, feature extraction may include representations learned by a prior version of neural network, such that neural network may receive feedback to more efficiently and accurately extract significant aspects from new data (e.g., image data). In one or more embodiments an extractor classifier may be used to categorize the identified objects and/or features on environment from image data. For instance, neural network feature extractor may use a sub-classifier to classify objects from the background (e.g., environment), and a second sub-classifier to classify detected objects alone (e.g., object). Neural network feature extractor may be used to determine attributes of environment and/or object. For instance, neural network feature extractor may determine bounds and metes of environment and/or objects, such as edges, corners, curves, lines, and the like. For example, neural network feature extractor may identify body of water, and the dimensions of body of water, within environment. In another instance, neural network feature extractor may identify object and attributes of object.

In one or more embodiments, processing unit 101 may, using one or more segmentation convolutional neural networks, be configured to identify one or more metes and bounds of a body of water within environment 107 (e.g., pool edges) and map them on a common plane for all cameras using a homography matrix for perspective transformation. In one or more embodiments, processing unit 101 may be configured to define perspective transform homography matrixes using an installer-guided simple calibration process, which includes exposing a single object of known size and shape to imaging modules.

Steps 312 through 317 include sub-steps of step 304 for 3D tracking of objects within environment 107 using, for example, a tracking model (e.g., a 3D tracker). As shown in step 312 of method 320, method 320 may localize detected objects (e.g., object 106) in a 3D-coordinate system of environment 107 using, for example, back projection techniques. In one or more embodiments, algorithm used by system 100 may utilize the previous localization information, lines of sight to the objects' detected points that include the ground/water contact point, lines of sight of known points in the environment, a contact point of the line-of-sight points with the ground plane, and/or triangulation techniques.

As shown in step 313 of method 320, method 320 may include tracking model being configured to execute single camera track and detection association by cost matrix matching of extracted feature association, location, Intercept-over-Union (IoU) of high confidence detections with existing tracks, IoU of Observation-Centric Recovery corrected track, IoU with low threshold past detections, and the like. Each parameter considered may be weighted by the size of the detection, the context of the scene (e.g., known crowded scene, previous known direction and speed of object, etc.), and the like.

As shown in step 314 of method 320, method 320 may include executing, by tracking model, single camera track management, based on track history and/or locations. In one or more embodiments, executing single camera track management may be based on track history. In one or more non-limiting embodiments, one or more imaging modules may be configured to auto-track an object within environment. In one or more embodiments, processing unit 101 may be configured to run a multi-camera tracking algorithm to manage the tracks of single camera tracking outputs.

As shown in step 315 of method 320, method 320 may include executing, by tracking model, Observation-Centric Smoothing, Observation-Centric Momentum, Estimation-Centric Smoothing, and the like.

As shown in step 316 of method 320, method 320 includes, executing, by tracking model, cost matrix matching to associate tracked objects (e.g., object 106) of one imaging module with tracked objects (e.g., object 106) of second imaging module, based on, for example, 3D locations and extracted features. In one or more embodiments, executing cost matrix matching may occur after object 106 has been confirmed in a single camera space, by being seen enough times (e.g., predetermined times w), with acceptable neural network confidence and appropriate locations.

As shown in step 317 of method 320, method 320 includes executing, by tracking model, single final track management, based on track history and/or locations.

In one or more non-limiting embodiments, the information of the neural network detector (step 302) and neural network feature extractor (step 303) are integral to 3D tracker (step 304) functionality of system 100. A 2D-to-3D back projection calculation may be executed (step 312) for each object that has a neural network confidence threshold above a configurable number, which locates each detection on a common plane. Each isolated detection is then attempted to be associated with existing tracks from previous frames using a cost matrix matching algorithm (step 313) where each element of the cost matrix can be configured dynamically regarding its order and importance (weight). Elements in the matrix may include, but are not limited to, extracted features correlation, 3D distance correlation, Intercept-over-Union (IoU) of high confidence detections with existing tracks, Intercept-over-Union of high confidence detections with Observation-Centric Recovery corrected tracks, Intercept-over-Union with low threshold old detections. Still operating in single camera space, a track management (step 314) algorithm manages all tracks to several states of confirmation. Although not limited to this list, examples of states may include tentative track, confirmed track, deleted track, and the like. Tracks' trajectories and positions may then be smoothed using motion estimation algorithms (step 315) utilizing a few algorithms where each provides a different approach. Such algorithms may include, but are not limited to, Observation-Centric Smoothing, Observation-Centric Momentum, Estimation-Centric Smoothing. At each of the steps of method 300, the Object Database (step 318) may be updated with the latest information and/or data.

After objects have been confirmed in single camera space by being seen with high confidence by a configurable number of consecutive frames, each imaging module's tracks get associated with one or more other imaging module tracks (step 316) by executing a dynamically configurable cost matrix matching algorithm. Elements of the matrix may include, but are not limited to, 3D location correlation and extracted feature correlation. A final track management algorithm manages the final track status to several states of confirmation (step 317). States may include, but are not limited to, orphan tracks, matched orphan tracks, matched single sensor tracks, object associated tracks, matched tracks, unmatched tracks, possible new object, deleted tracks, and the like.

In one or more embodiments, processing unit 101 may be configured to use a state machine to determine the behavior of system 100, which takes in all the system inputs and derived inputs, resulting in a change of behavior of system 100 according to, for example and without limitation, the age of each patron, the context of the patron's presence, the direct interactions with other patrons, the movement style of the patrons, the sound made by patrons, the directives given by a responsible patron, the user-selected mode of operation, non-pool-time, pool-time, out-of-season setting, good-swimmers-only, swimming skill level, identification, location, direction, speed, supervisory presence, medical condition risk, dangerous situation identification, and the like.

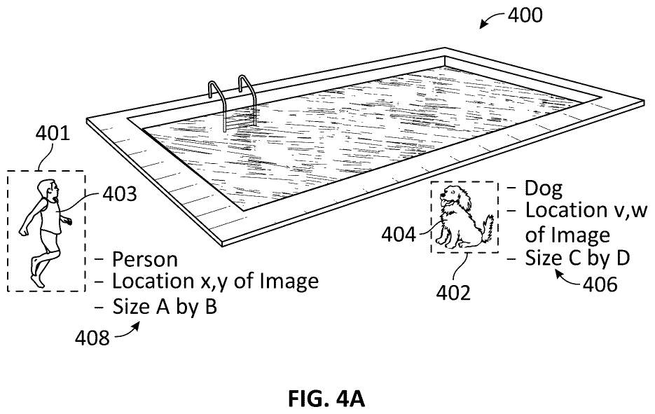

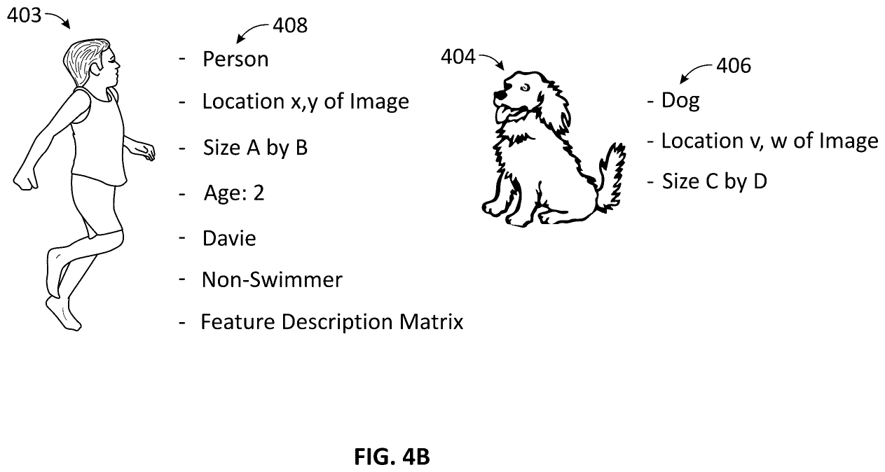

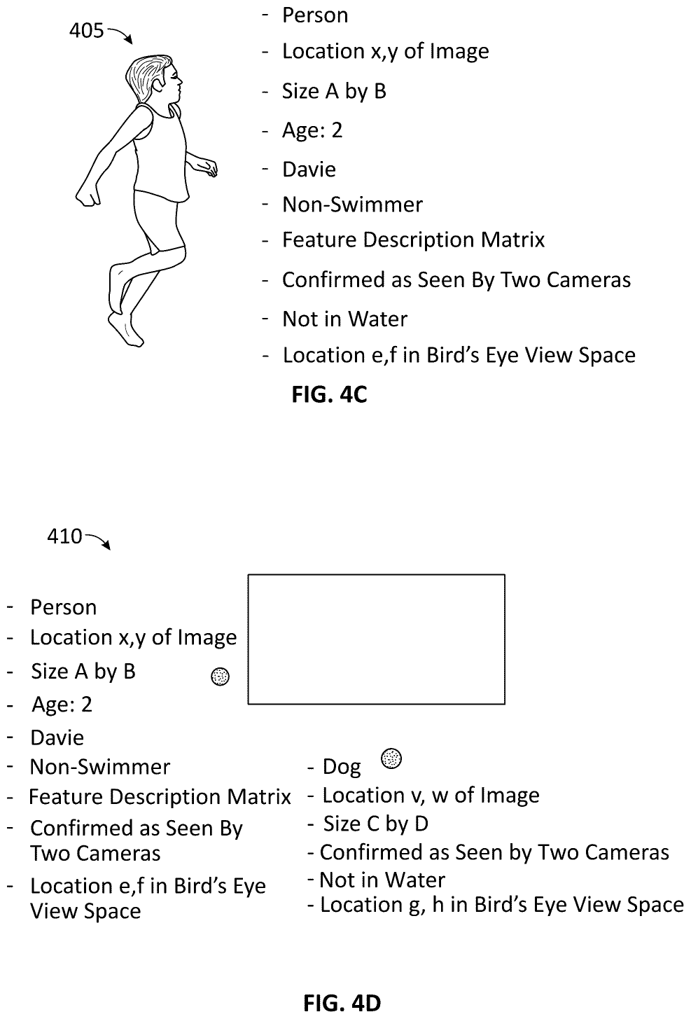

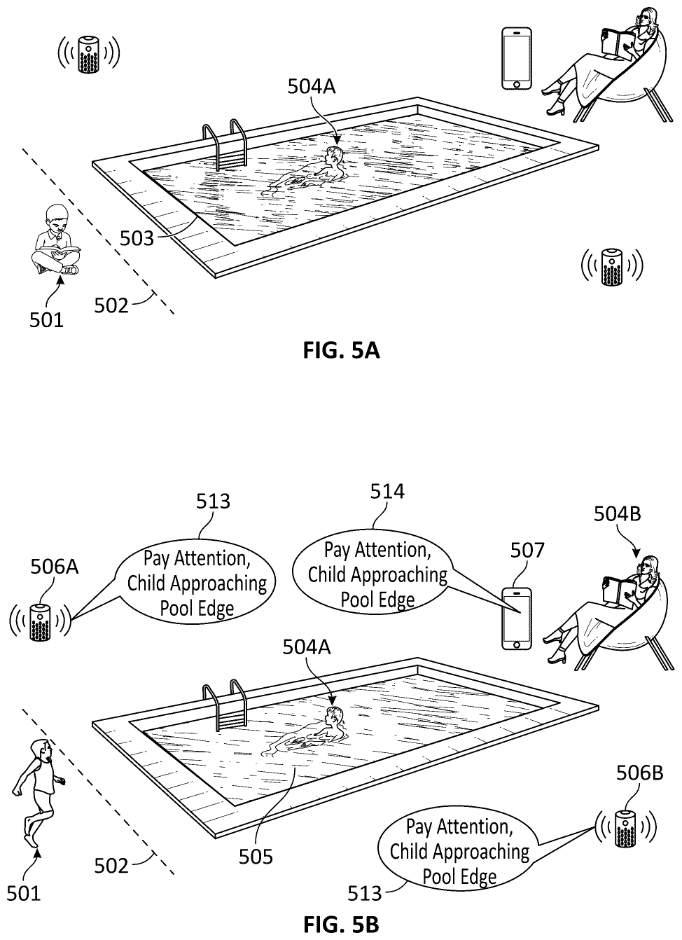

Now referring to FIGS. 4A-4D, various schematic illustrations of exemplary embodiments of visual representations of objects 403 and 404 are shown. Determining status data of objects may include tracking an object in real time using tracking model described in FIGS. 3A and 3B. Status data may also be continuously updated by system 100 based on continuously tracking object (e.g., objects 403 and 404). Object identifier 408 may be associated with object 403, and object identifier 406 may be associated with object 404. Object identifiers may be displayed alongside associated objects. Visual indicators or annotations may be used to highlight information or provide additional information about objects. For example, indicator 401 may highlight object 403, and indicator 402 may highlight object 404 so that a user may readily locate objects within environment of video 400.

As shown in FIG. 4A, in one or more embodiments, processing unit 101 may provide outputs at various steps of processing images (such as images 301a,b of FIGS. 3A and 3B). For instance, each image or video comprising images 301a,b may be received, decoded, and available to be processed by the neural network detector, as discussed above in FIGS. 3A and 3B. In one or more embodiments, processing unit 101 may generate and use a neural network, such as a convolutional neural network detector (shown in FIGS. 3A and 3B), to locate an image space of image data (e.g., an image or video 400) having one or more objects shown therein. Additionally, neural network detector may classify one or more objects, such as objects 403 and 404 that include a toddler classified as a person and a dog classified as an animal. For instance, neural network detector may determine that a first object falls within the category of a person while a second object falls within the category of an animal. In one or more embodiments, a classifier may be used to categorized different objects into category bins, as previously mentioned in this disclosure. The outputs of neural network detector may include, but are not limited to, the classification of objects that have been found, and their location, size in the image that was processed, and the cropped images of objects. Although not limited to this list, examples for objects of interest may include a person, a person-in-water, a submerged person, an animal, a pet, a dog, a person's head, an inflatable boat, a contact point of a person in water, and the like.

Still referring to FIGS. 4A-4D, cropped images of objects 403,404 may be outputted and created by neural network detector, as described in step 302 of FIG. 3A, and may then be each processed further by neural network feature extractor (e.g., neural network feature extractor algorithm), as described in step 303 of FIG. 3A. As previously mentioned in this disclosure, neural network extractor algorithm may provide descriptive information 406,408 (e.g., object identifiers) that is appended to a particular object 403,404, respectively. Object identifiers may be associated with objects, such as objects 403 and 404 of FIG. 4B and object 405 of 4C. FIGS. 4A-4D also include exemplary visual representations of object identifiers. For instance, display 140 may show an image of object 405 of FIG. 4C with a textual superimposition of object identifiers related to object 405. FIG. 4D shows another exemplary embodiment of a visual representation 410, where object identifiers are shown along with locations of objects within environment.

Now referring to FIGS. 5A-11, schematic diagrams illustrating exemplary operations of system 500 are shown. As understood by one of ordinary skill in the art, system 500 and components thereof may be the same or similar to system 100 described above in this disclosure. The behavior and actions by system 500 in various situations is critical in its successful operation.

Referring to FIGS. 5A-5F, system 500 may follow each object, such as a toddler 501, and determine status data on each object detected within environment 518 In one or more embodiments, system 500 may locate objects within environment 518, such as within a pool area, determine if toddler 501 is submerged within a body of water (e.g., pool 505) of environment 518, determine the duration of time toddler 501 has been submerged, determine an age or age range of toddler 501, identify toddler 501 by a name if toddler is recognized or if a user inputs such identification information, such as a name, of object manually, determine if toddler 501 is under direct supervision by a caregiver or supervisor, such as by caregivers 504a and 504b, or user of system 500, and compare the behavior of toddler 501 with historical behavior (e.g. object identifier) of object, or other objects with similar information to object (e.g., age range and swimming proficiency).

In one or more embodiments, alerts, such as audio alerts 513 and visual alert 514, may be generated by system 500 if a critical event is determined. Critical event may include, without limitation, a non-swimmer crossing a predetermined boundary 502 of body of water, a non-swimmer entering body of water, a non-swimmer being submerged within body of water over a predetermined duration of time, and the like. Alerts generated by system 500 may be tailored based on data associated with toddler 501 and environment. For instance, levels of alert may be tailored to each person depending on their identification information, status data, and/or difference between status data and distress condition. As previously mentioned in this disclosure, object identifier (e.g., identification information) may include information related to a swimming proficiency of a detected and/or identified object. As shown in FIG. 5A, toddler 501 with a status of a non-swimmer, is not moving and outside of water proximity parameter or boundary 502 (e.g., risk distance) from an edge of body of pool 505 so no critical event is occurring and the situation is normal (e.g., safe) while caregivers 504a,b are absorbed in their personal activities.

In FIG. 5B, a continuation of the scenario from FIG. 5A is continued, wherein toddler 501 is still outside of predetermined distance parameter (e.g., the water proximity parameter, such as a boundary 502) positioned at a distance y from edge 503 of pool 505, but now moves quickly (e.g., at a velocity v) toward pool 505. System 500 recognizes the potential danger early, determines there is a critical event, and warns the caregivers 504a,b since each caregiver is considered far from toddler 501. In one or more embodiments, a voice message (such as audio alert 513) may be transmitted as an output to various components of system 500, such as audio modules 506a and 506b and a user device 507 (e.g., push notification or visual message 514 may be sent to user device 507 of one or more of the caregivers).

As illustrated in FIG. 5C, in this exemplary scenario, the previous warning from FIG. 5B was not acted on by caregivers 504a,b and toddler 501 continues to move closer to the pool edge 503 (e.g., updated status data that include a new location or distance of toddler 501) such that distance x between toddler 501 and pool edge 503 has been further reduced since the first alert of FIG. 5B. Based on the inaction of caregivers 504a,b, processing unit 101 may generate a second alert, such as alerts 508a, 508b, and/or 509. Second alert may include a loud piecing whistle sound, such as outputs of audio alerts 508a,b from audio modules 506a,b, respectively, and generate a second visual alert 509 (e.g., text message) that is transmitted to user device 507, followed by a voice that explains alert. For example, an alert having a voice message may include the phrase “Child is within the risk area.”

As illustrated in FIG. 5D, a third alert may be generated if user, such as caregivers 504a,b, fail to respond to second alert. For instance, if caregivers 504a,b fail to respond to second alert and updated status data shows that toddler 501 continues to reduce distance x between pool edge 503 and toddler 501 by continuing to move toward pool 505, system 500 may generate a similar loud piecing whistle alert sounds and relevant voice message 510a and 510b. In this example, toddler 501 did not stop and caregivers 504a,b did not take appropriate action.

As illustrated in FIGS. 5E and 5F, system 500 may escalate levels of alert by increasing a volume of audio alert (e.g., piercing alert sound 511 and 512) and repeating any sounds constantly until corrective actions are taken and the critical event has ended.

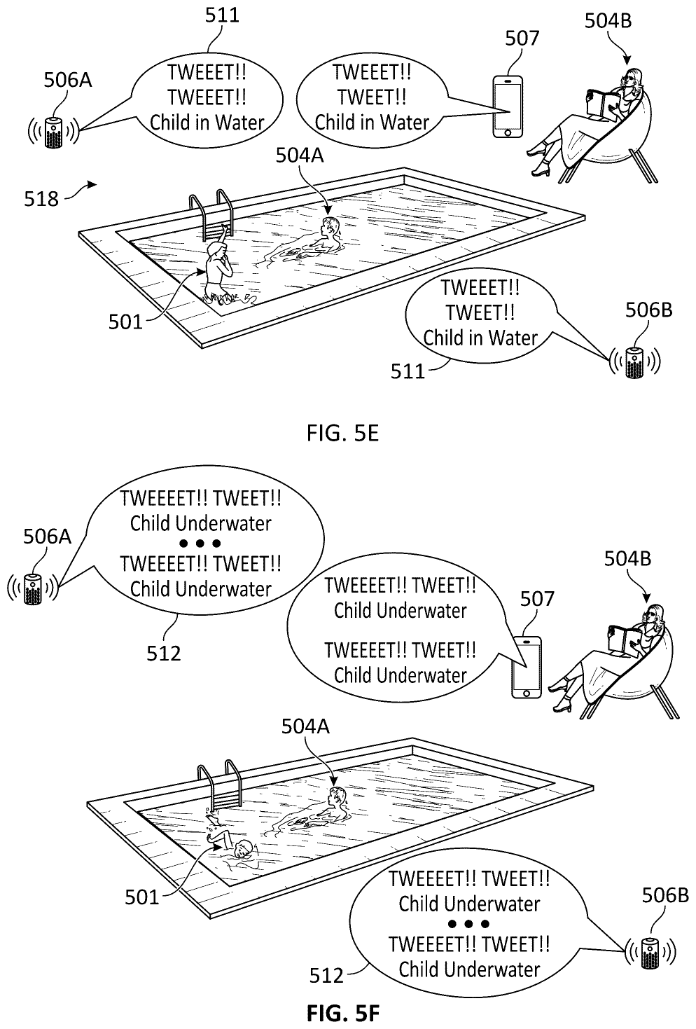

Now referring to FIG. 6, a schematic diagram of another exemplary embodiment of system 600 is shown. System 600, and components thereof, may be the same as or similar to pervious systems 100,500 described in this disclosure. As shown in FIG. 6, a toddler 601 present without supervision of a user of system 600 (e.g., a caregiver or supervisor) but in a safe area (e.g., an area outside of boundary 603) of pool 604 may still be considered a critical event and result in system 600 generating an alert 602, where alert 602 may include a higher-level alert since toddler 601 is alone in environment with pool 604.

Now referring to FIGS. 7A-7F, processing unit, such as processing unit 101, may be further configured to adjust one or more distress parameters, such as distress parameters 132. In one or more embodiments, system 100 may include specific distress parameters for every object based on information that was gathered on object (e.g., object identifier 126 and/or status data 130) and environment 706. In various embodiments, there are situations that user of system 100 may wish to change those distress parameters to temporally eliminate false alarms by system 100. Although there are many possible scenarios, FIGS. 7A-7F illustrate one exemplary scenario where a caregiver 701 may want to relax the distress parameters of system 100. As shown in FIGS. 7A and 7B, a caregiver 701 is training a child 702 to swim underwater. Since child 702 is a non-swimmer, system 100 may keep a very low allowable time for him to be underwater before an alert is generate and an alarm is raised. As illustrated in FIG. 7B, caregiver 701 may proceed to guide child 702 underwater, system 100, as shown in FIG. 7C, may generate an alert 703 in response to child 702 being submerged beneath a surface of body of water for over a predetermined duration of time, interrupting the lesson.

As shown in FIG. 7D, in some embodiments, system 100 may recognize signaling gestures or verbal commands from caregiver 701 that adjust predetermined duration of time for submergence of child 702. There are various gestures that system 100 may recognize using various image processing techniques. An exemplary signalizing gesture of caregiver 701 may include, for example, a “time-out” gesture 704, which may include a visual “key” that triggers system 100 to look for a second gesture, wherein second gesture may include a command to adjust a distress parameter. For example, second gesture 705 may signal a command.

In one or more embodiments, a command from a user, such as caregiver 701, may be accepted to relax one or more distress parameters that critical event may be determined based off of. As illustrated in FIG. 7E, system 100 may generate a verbal announcement 708 that distress parameter has been permanently or temporarily adjusted and/or altered by caregiver 701. For example, after processing unit 101 receives command signal from caregiver 701 based on, for example, image data and or audio data, processing unit may extend the predetermined duration of time such that child 702 can be submerged below the surface of body of water for any duration of time without generating an alert. The caregiver 701 and child 702 may then continue with their lesson, as shown in FIG. 7F.

In one or more embodiments, system 100 may automatically return to previously set distress parameters if caregiver 701 and child 702 are determined to be separated by an unsafe distance (e.g., exceed a threshold of a supervisor proximity parameter). Although the child appeared to be under direct supervision, there are unfortunately cases where a caregiver may get momentarily distracted (e.g., by another child) and the child end up underwater for too long. Thus, in some embodiments, system 100 may never be fully disengaged.

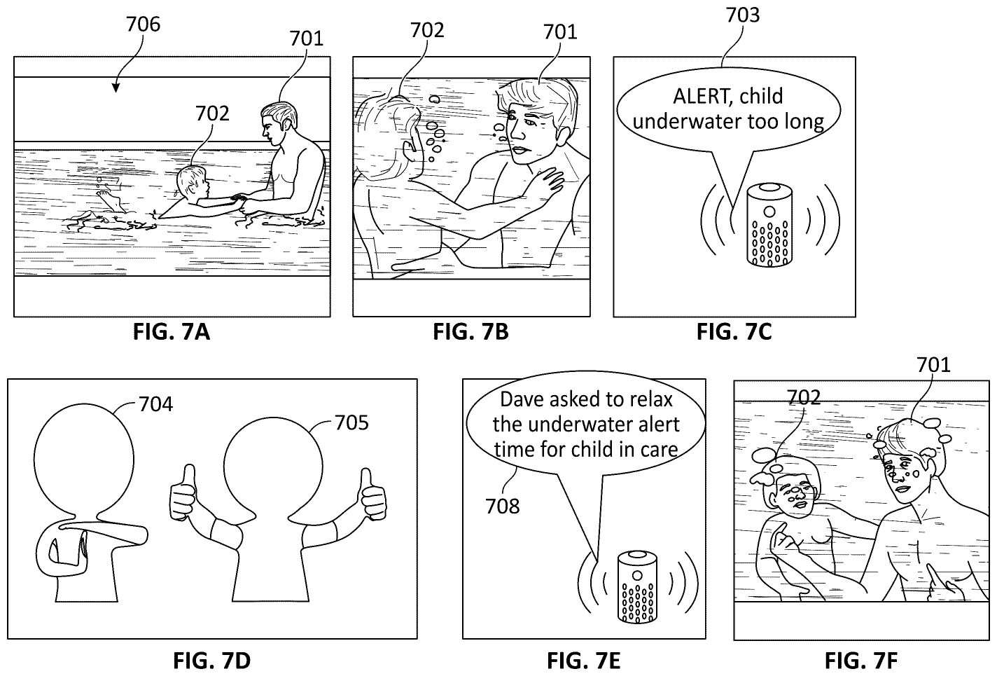

Now referring to FIG. 8, in various embodiments, a schematic diagram showing another exemplary scenario for use of system 100 is shown. Similar to human lifeguards, system 100 can recognize dangerous situations, and require the “culprits” to stop any dangerous behavior (e.g., behavior that triggers a critical event determination). For example, and without limitation, processing unit 101 may determine that a situation where a child 801 is jumping on another child 802 in a pool is a critical event. In one or more embodiments, critical event may be determined in such a situation based on image data, object identifiers, status data, and/or one or more distress parameters. For example, status data may include 3D positions of one or more objects, a velocity of one or more objects, and a direction of one or more objects. If a critical event is determined, processing unit 101 may generate an alert by, for example, generating a human lifeguard-like warning 803, using audio module 103. Critical events may include, but are not limited to, one person jumping on another person, a person running on wet pavement, a person diving into shallow water, excessive splashing by one or more objects, and the like.

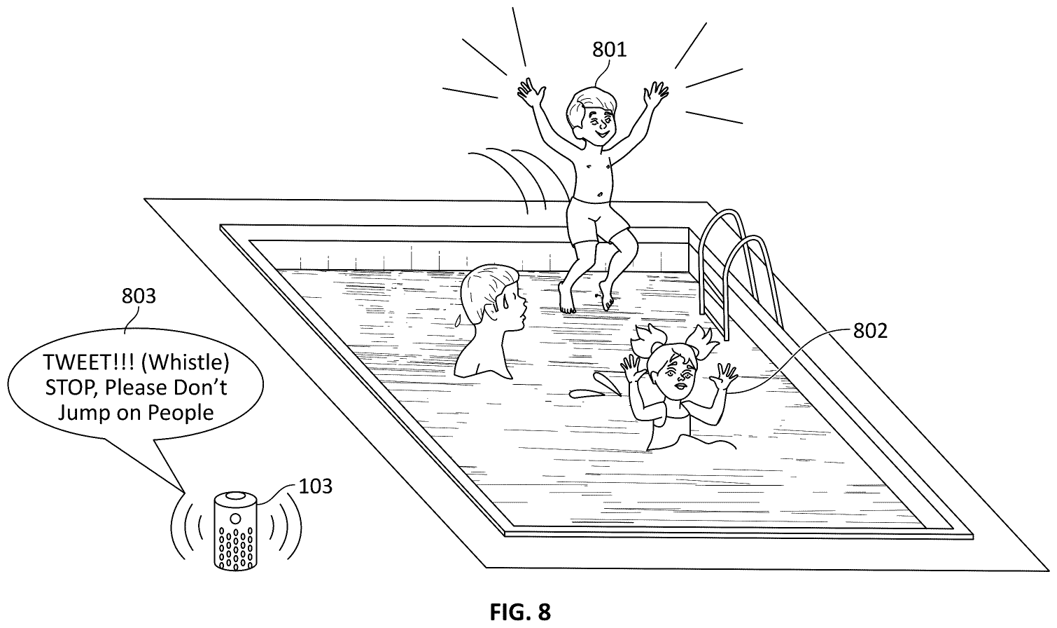

Unfortunately, even in crowded situations, there are many cases of drownings. System 100 may never disengage and constantly monitor all objects (e.g., patrons) for underwater time. FIG. 9 illustrates a schematic diagram showing an exemplary scenario where the engagement of a large party has all attendees (e.g., objects) distracted from supervising at the pool, such that no one is focused on a non-swimmer child 901. In various embodiments, system 100 may never be disengaged completely, and thus alert 902 will always be generated, regardless of the appearance of supervision (e.g., supervisor proximity parameter set to minimal threshold). System 100 may only be relaxed in its limits before an alarm is generated, but never fully disengaged.

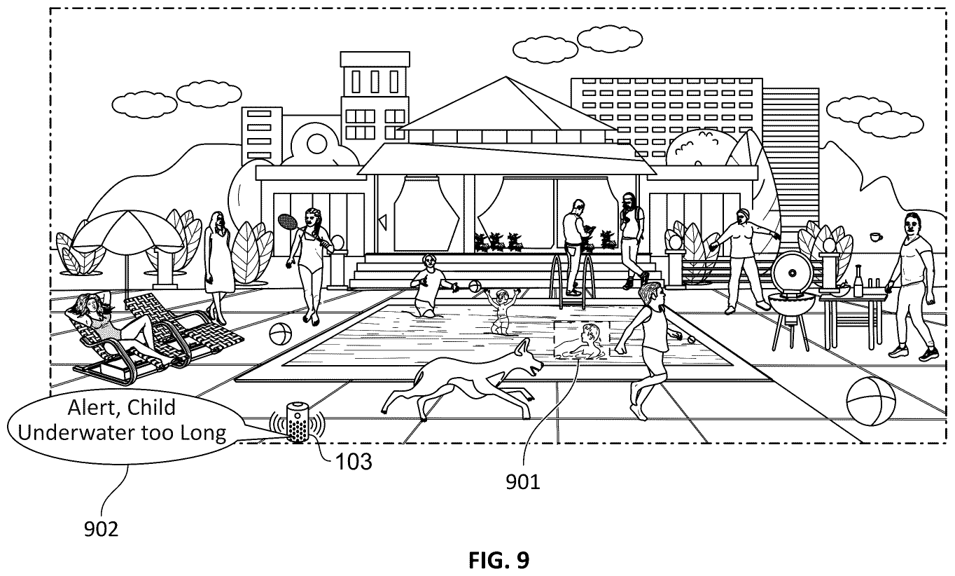

Now referring to FIG. 10, a schematic diagram of another exemplary scenario for use of system 100 is shown. More specifically, FIG. 10 shows a scenario where a swimmer 1001 is barely able to stay afloat due to, for example, a medical reason. The monitoring of swimmer's underwater time is not effective to assist in this case since his object identifier includes information identifying him as a proficient swimmer and thus the associated predetermined threshold for a default time to be underwater may be too long for him in his weakened condition. Audio modules 1002 may include microphones. In one or more embodiments, system 100 may actively (e.g., continuously) process transmissions from microphone and thus processing unit may determine status data that includes distress words. If a distress word 1003 is recognized, a critical event may be determined and an alert 1004 may be generated.

In one or more embodiments, system 100 may include two imaging modules, as previously mentioned, so that image data is continuously being received by processing unit. One imaging module may be temporarily sufficient, but like a human lifeguard, system 100 may generate an alert that may be sent to one or more users through, for example, text messages, to remove obstructions when one or more imaging module has a decreased function or is inoperative.

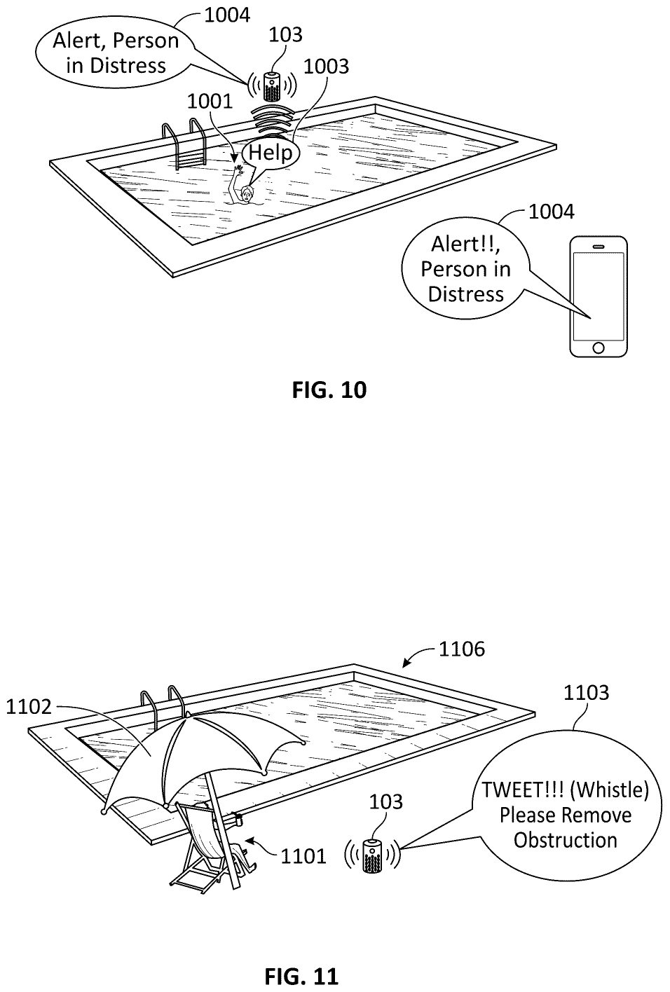

FIG. 11 illustrates an exemplary embodiment of system 100 detecting an obstruction 1102 (e.g., umbrella) that blocks at least a portion of an environment 1106 within a field of view of one or more imaging modules. As previously mentioned in FIGS. 1A and 1B, processing until may identify an obstruction within environment and alert a user of the obstruction in order to remove the obstruction from a field of view of one or more imaging modules of system. For example, an object, such as a patron 1101, may install an obstruction 1102, such as an umbrella, that obstructs a large portion of environment and/or pool. In one or more embodiments, system 100 may identify obstruction 1102 and generate an alert or warning 1103 using, for example, audio module 1104 or messaging a registered smart device (e.g., remote user device).

As shown in FIG. 12, system 100 may be calibrated to improve accuracy and/or efficiency of system 100. For example, calibration process may include identifying an object, such as a baseline object 1203, of known shape and size and within the field of view of both imaging modules 102a,b simultaneously. An user or installer of system 100 may use a smartphone to video record the environment as the user walks around the environment while being simultaneously recorded by imaging modules 102a,b. Image data from imaging modules 102a,b and user device may then be used to create a 3D point cloud or dense mesh of the environment. In one or more embodiments, processing unit 101 may transfer the image data captured from each imaging module 102a,b regardless of the point of view of the imaging modules, onto a 3D coordinate system rendering of the environment. Actual true dimensions are determined in the back projection algorithm, and used in the system operation. This transform operation may require a calibration step.

In one or more embodiments baseline object's 1203 precise dimensions and features may be used to provide some known dimensions environment using algorithms. The baseline object 1203 used for calibration may be a meter square, with at least one unique feature 1204 that enables the system to determine its orientation. In the case where the object is a meter square, the corners of the object may be easily and precisely identified in the images captured from both imaging modules 102a,b, and the distance between each point is known due to the shape of the object.

In one or more embodiments, these same calibration captured images, may be provided to a segmentation convolutional neural network to automatically determine the edges of the pool. The pool edges are also precisely transferred to the 3D coordinate system of the environment that the system works with.

A system with a high level of capability may have the opportunity to add supplemental functionality that provides value beyond pool safety. The system cameras, speakers, and processing power may enable fun games and fitness activities. Although not limited to this list, the following interactions may be enabled alongside the pool safety features running concurrently: red-light-green-light game, Simon-says game, guess-who game, hold-your-breath game, lap-racing game. The listed functionality may be implemented utilizing the same system blocks as in the pool drowning prevention application, but the status of each patron may be used by a parallel application to guide the gestures and audio output to coordinate the games.

In the realm of security, the system may include intruder alerts functionality. A lot of the functionality of home security systems are already being performed by the guardian system. Although not limited to this list, extra security features may include, but are not limited to, long term recording and storage capability, stored video browsing, extra cameras support, abnormal path detection, virtual fence definition and breach detection, uniform classification, package left behind. The intruder detection functionality is a sub-set of the functionality that is already provided to implement the pool safety features; the extra features desired for a home security system are merely extensions, with a different user interface that is tailored to the security market.

The audio modules and the system smart device app, which all include a speaker and microphones, enable the implementation of an intercom functionality. A caregiver busy somewhere in the house may hear the sounds from the pool and give voice instructions to the pool side. The user interface may enable streaming of sound from the pool to any audio module or smartphone system app and enable audio streaming from the smartphone app to the pool speakers.

The system may also interface with external complimentary systems and sensors to provide further inputs to identify the situation and the correct action. Although no limited to this list, examples of such systems and sensors are floating buoy alerting when water is displaced, radar sensor output pointing at the pool area, sonar sensor output located in the pool, longwave infrared sensor cameras imaging the pool area, smart speaker voice recognition, security system door alarms, security system motion detection.

The system speakers may be used to stream music, with the processing unit still having priority to play the files that it wants at any time and without delay.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present disclosure. Accordingly, the scope of the disclosure is defined only by the following claims.

What is claimed is:

1. A water surveillance system comprising:
two or more imaging modules, wherein each of the two or more imaging modules is configured to provide image data of an environment comprising a body of water;
a processing unit communicatively connected to the two or more imaging modules; and
a memory communicatively connected to the processing unit, wherein the memory comprises instructions configuring the processing unit to:
receive the image data of the environment from each of the two or more imaging modules;
identify, using a neural network, one or more objects within the environment based on the image data, wherein identifying the one or more objects comprises associating an object identifier with each of the one or more objects;
determine status data of the one or more objects based on the image data;
provide a distress parameter based on the object identifier;
determine a critical event related to at least one of the objects of the one or more objects based on the status data and a distress parameter; and
generate an alert based on the determination of the critical event.

2. The system of claim 1, wherein the two or more imaging modules comprises at least:
an infrared imaging module, wherein the infrared imaging module is configured to provide infrared image data;
a visible spectrum imaging module, wherein the visible spectrum imaging module is configured to provide visible spectrum image data; and
wherein each of the two or more imaging modules are positioned at a different location relative to each other to provide a different angle of view of the environment.

3. The system of claim 1, further comprising a display having a user interface providing graphics, wherein:
determining the status data of the one or more objects comprises tracking, using a tracking algorithm, a movement of the one or more objects within the environment;
determining the critical event further comprises comparing the movement of the one or more objects to a threshold of the distress parameter;
the tracking changes a corresponding weight of each level of a cascade matching algorithm based on a current situation, a status of the system, and/or detection characteristics; and
the processing unit is further configured to render, on the display, a three-dimensional (3D) tracking view on the display comprising visual indicators for each of the one or more objects in the environment based on the tracking and/or object identifiers of the one or more objects.

4. The system of claim 1, wherein:
the status data comprises a current location of the one or more objects and/or a submergence of the one or more objects;
the distress parameter comprises a predetermined duration of time for submersion beneath a surface of the body of water; and
determining the critical event comprises determining that a first object of the one or more objects has been submerged beneath the surface of the body of water for more than the predetermined duration of time.

5. The system of claim 1, further comprising an audio module having at least:
a speaker; and
a microphone configured to provide audio data to the processing unit;
wherein the audio module is communicatively connected to the processing unit and configured to:
detect a status of a communicative connection of the audio module with the processing unit; and
generate, if the status comprises a malfunction status, a verbal warning announcing a failure of the communicative connection; and
wherein determining the critical event is further based on the audio data.

6. The system of claim 1, further comprising a database and a feature extractor convolutional neural network, wherein:
the identifying further comprises storing, in the database, identification information for each of the one or more objects, wherein the identification information is: (i) associated with the object identifier of one of the one or more objects and (ii) comprises an age of the one or more objects, a presence of a supervisor, and/or a swimming skill level of the one or more objects; and
providing the distress parameter based on the object identifier is further based on the identification information associated with the object identifier in the database.

7. The system of claim 1, wherein:
the critical event comprises an object of the one or more objects being underwater for too long, approaching an edge of the body of water as a non-swimmer, running on wet pavement, and/or jumping or diving on another object; and
determining the critical event comprises identifying a level of the critical event; and
generating the alert is based on the level of the critical event.

8. The system of claim 1, wherein the processing unit is further configured to:
determine an updated critical event based on an updated status data, wherein the updated critical event comprises a deescalated critical event, wherein the deescalated critical event comprises an object of the one or more objects re-surfacing above water before a specific predetermined duration of time for submergence is exceeded, a command gesture of a user, a presence of a supervisor, and/or a command gesture of the supervisor;
identify an obstruction blocking at least a portion of a field of view (FOV) of the two or more imaging modules;
generate, in response to the identifying the obstruction, a notification to instruct a user to remove the obstruction from the at least a portion of the field of view of the one or more imaging modules; and
report a functionality status to a communicatively connected cloud server to enable the cloud server to alert a user if a malfunction of the system is detected; and
wherein identifying each object of the one or more objects within the environment further comprises:
re-identifying the object if the object has been previously identified; and
re-identifying the object as the same object if the object has been occluded by the obstruction and re-appeared in a field of view of one or more of the imaging modules; and
wherein the neural network comprises a feature extractor neural network.

9. The system of claim 1, wherein:
the identifying each object of the one or more objects comprises: (i) classifying the object as a user, supervisor, other person, or animal, (ii) determining a submergence level of the object and a center contact point of the object if the submergence level exceeds a depth threshold; (iii) a head of the object, and/or (iv) a robustness of the identifying of the object;
the status data comprises an age of each of the one or more objects, a context of each of a presence of the one or more objects, a direct interaction of each of the one or more objects with one of the one or more objects, a movement style of each of the one or more objects, a sound made of each of the one or more objects, a directive given by the supervisor, a user-selected mode of operation, a swimming skill level of each of the one or more objects, an identification of each of the one or more objects, a location of each of the one of more objects within the environment, a direction of each of the one or more objects, a speed of each of the one or more objects, a medical condition risk, and/or a dangerous situation identification;
the processing unit is further configured to:
determine that the image data comprises a visual representation of a command gesture from a user or the supervisor;
identify the command gesture;
alter the status data of at least one of the one or more objects and/or the distress parameter based on the command gesture; and
receive a user input comprising instructions to alter a mode of operation of the system, wherein the mode of operation comprises gamification, communication, entertainment modes, a non-pool-time setting, a pool-time setting, an out-of-season setting, and a good-swimmers-only setting, and wherein the gamification mode comprises Simon says, red-light-green-light, and race coordination games.

10. The system of claim 1, wherein:
a pixel density of the image data is large; and
the two or more imaging modules are further configured to:
in response to a zoom signal, generate a crop of the image data, wherein the crop:
(i) is a desirable framing of the environment, and (ii) associates a desirable amount of the image data with each of the one or more objects; and
wherein the processing unit is further configured to send the zoom signal in response to a distance between one of the two or more objects and one of the one or more objects meeting a distance threshold or a classification quality of the neural network meeting a precision threshold.

11. A method for monitoring an environment having a body of water using a water surveillance system, the method comprising:
providing, by two or more imaging modules, image data of an environment comprising a body of water;
receiving, by a processing unit communicatively connected to the two or more imaging modules, the image data of the environment from each of the two or more imaging modules;
identifying, by a neural network of the processing unit, one or more objects within the environment based on the image data, wherein identifying the one or more objects comprises associating an object identifier with each of the one or more objects;
determining, by the processing unit, status data of the one or more objects based on the image data;
providing, by the processing unit, a distress parameter based on the object identifier;
determining, by the processing unit, a critical event related to at least one of the objects of the one or more objects based on the status data and a distress parameter; and
generating, by the processing unit, an alert based on the determination of the critical event.

12. The method of claim 11, wherein the two or more imaging modules comprises at least:
an infrared imaging module, wherein the infrared imaging module is configured to provide infrared image data;
a visible spectrum imaging module, wherein the visible spectrum imaging module is configured to provide visible spectrum image data; and
wherein each of the two or more imaging modules are positioned at a different location relative to each other to provide a different angle of view of the environment.

13. The method of claim 11, wherein the system further comprises a display having a user interface providing graphics, and wherein:
determining the status data of the one or more objects comprises tracking, using a tracking algorithm, a movement of the one or more objects within the environment;
determining the critical event further comprises comparing the movement of the one or more objects to a threshold of the distress parameter;
the tracking changes a corresponding weight of each level of a cascade matching algorithm based on a current situation, a status of the system, and/or detection characteristics; and
the method further comprises rendering, by the processing unit, on the display, a three-dimensional (3D) tracking view on the display comprising visual indicators for each of the one or more objects in the environment based on the tracking and/or object identifiers of the one or more objects.

14. The method of claim 11, wherein:
the status data comprises a current location of the one or more objects and/or a submergence of the one or more objects;
the distress parameter comprises a predetermined duration of time for submersion beneath a surface of the body of water; and
determining the critical event comprises determining that a first object of the one or more objects has been submerged beneath the surface of the body of water for more than the predetermined duration of time.

15. The method of claim 11, wherein the system further comprises an audio module having at least:
a speaker; and
a microphone configured to provide audio data to the processing unit;
wherein the method further comprises:
detecting a status of a communicative connection of the audio module with the processing unit; and
generating, if the status comprises a malfunction status, a verbal warning announcing a failure of the communicative connection; and
wherein determining the critical event is further based on the audio data.

16. The method of claim 11, wherein the system further comprises a database and a feature extractor convolutional neural network, and wherein:
the identifying further comprises storing, in the database, a identification information for each of the one or more objects, wherein the identification information is: (i) associated with the object identifier of one of the one or more objects and (ii) comprises an age of the one or more objects, a presence of a supervisor, and/or a swimming skill level of the one or more objects; and
providing the distress parameter based on the object identifier is further based on the identification information associated with the object identifier in the database.

17. The method of claim 11, wherein:
the critical event comprises an object of the one or more objects being underwater for too long, approaching an edge of the body of water as a non-swimmer, running on wet pavement, and/or jumping or diving on another object; and
determining the critical event comprises identifying a level of the critical event; and
generating the alert is based on the level of the critical event.

18. The method of claim 11, wherein the method further comprises:
determining, using the processing unit, an updated critical event based on an updated status data, wherein the updated critical event comprises a deescalated critical event, wherein the deescalated critical event comprises an object of the one or more objects re-surfacing above water before a specific predetermined duration of time for submergence is exceeded, a command gesture of a user, a presence of a supervisor, and/or a command gesture of the supervisor;
identifying, using the processing unit, an obstruction blocking at least a portion of a field of view (FOV) of the two or more imaging modules;
generating, in response to the identifying the obstruction, a notification to instruct a user to remove the obstruction from the at least a portion of the field of view of the one or more imaging modules; and
reporting, using the processing unit, a functionality status to a communicatively connected cloud server to enable the cloud server to alert a user if a malfunction of the system is detected; and
wherein identifying each object of the one or more objects within the environment further comprises:
re-identifying the object if the object has been previously identified; and
re-identifying the object as the same object if the object has been occluded by the obstruction and re-appeared in a field of view of one or more of the imaging modules; and wherein the neural network comprises a feature extractor neural network.

19. The method of claim 11, wherein:
the identifying each object of the one or more objects comprises: (i) classifying the object as a user, supervisor, other person, or animal; (ii) determining a submergence level of the object and a center contact point of the object if the submergence level exceeds a depth threshold; (iii) a head of the object; and/or (iv) a robustness of the identifying of the object;
the status data comprises an age of each of the one or more objects, a context of each of a presence of the one or more objects, a direct interaction of each of the one or more objects with one of the one or more objects, a movement style of each of the one or more objects, a sound made of each of the one or more objects, a directive given by the supervisor, a user-selected mode of operation, a swimming skill level of each of the one or more objects, an identification of each of the one or more objects, a location of each of the one of more objects within the environment, a direction of each of the one or more objects, a speed of each of the one or more objects, a medical condition risk, and/or a dangerous situation identification;
the method further comprises:
determining, by the processing unit, that the image data comprises a visual representation of a command gesture from a user or the supervisor;
identifying, by the processing unit, the command gesture; and
altering, by the processing unit, the status data of at least one of the one or more objects and/or the distress parameter based on the command gesture; and
the processing unit is further configured to receive a user input comprising instructions to alter a mode of operation of the system, wherein the mode of operation comprises gamification, communication, entertainment modes, a non-pool-time setting, a pool-time setting, an out-of-season setting, and a good-swimmers-only setting, and wherein the gamification mode comprises Simon says, red-light-green-light, and race coordination games.

20. The method of claim 11, wherein:
a pixel density of the image data is large; and
the two or more imaging modules are further configured to:
in response to a zoom signal, generate a crop of the image data, wherein the crop:
(i) is a desirable framing of the environment, and (ii) associates a desirable amount of the image data with each of the one or more objects; and
the method further comprises sending, by the processing unit, the zoom signal in response to a distance between one of the two or more objects and one of the one or more objects meeting a distance threshold or a classification quality of the neural network meeting a precision threshold.
